(19) United States
(12) Patent Application Publication
(10) Pub. No.: US 2015/0054784 A1
(43) Pub. Date: Feb. 26, 2015

(54) METHOD AND APPARATUS FOR EXECUTING APPLICATION USING MULTIPLE INPUT TOOLS ON TOUCHSCREEN DEVICE

(71) Applicant: SAMSUNG ELECTRONICS CO., LTD., Suwon-si (KR)

(72) Inventors: Min-sung KIM, Yongin-si (KR); Hyun-kwon CHUNG, Seoul (KR); Hye-soo KIM, Suwon-si (KR); Yong-seok JANG, Hwaseong-si (KR); Janine June C. LIM, Taguig City (PH); Jonathan Martin S. CRUZ, Taguig City (PH); Marwell D. DALANGIN, Taguig City (PH); Nicolai Andrew F. SINGH, Taguig City (PH); Timothy Israel D. SANTOS, Taguig City (PH)

(73) Assignee: SAMSUNG ELECTRONICS CO., LTD., Suwon-si (KR)

(21) Appl. No.: 14/468,537

(22) Filed: Aug. 26, 2014

Related U.S. Application Data
(60) Provisional application No. 61/869,854, filed on Aug. 26, 2013.

(30) Foreign Application Priority Data
Oct. 30, 2013 (KR) 10-2013-0130451
Jul. 21, 2014 (KR) 10-2014-0092156

(51) Int. Cl. G06F 3/046; G06F 17/30

(52) U.S. Cl. CPC G06F 3/046; G06F 17/30386
USPC 345/174

(57) ABSTRACT

Provided are a method of performing an event action by using a touch screen device based on operation gestures that are simultaneously input by using multiple operation tools and the touch screen device. The method includes: identifying a first operation tool based on contact by the first operation tool, the contact being sensed on the touch screen device; setting an operation area on the touch screen device based on an area designated by the contact by the first operation tool; identifying a second operation tool based on access by the second operation tool, the access being sensed on the touch screen device; sensing an operation gesture of the second operation tool within the operation area by using the second operation tool.

### RELATED APPLICATIONS

This application claims the benefits of U.S. Patent Application No. 61/869,854, filed on 26 Aug. 2013 in the United States Patent and Trademark Office and Korean Patent Applications No. 10-2013-0130451, filed on Oct. 30, 2013 and No. 10-2014-0092156 filed on Jul. 21, 2014, in the Korean Intellectual Property Office, the disclosures of which are incorporated herein in their entirety by reference.

### BACKGROUND

1. Field

One or more embodiments of the present invention relate to a method of operating a touch screen device by using an operation tool for a touch input to a touch panel.

2. Description of the Related Art

An input method in a device has started from a method using a key pad, and currently, a touch screen method is more frequently used, whereby a touch input of a user is received by using a touch recognition device which is included in a screen of a device.

Examples of devices to which a touch screen method is applied include various portable terminals such as portable phones including smartphones, MP3 players, personal digital assistants (PDA), portable multimedia players (PMP), play station portables (PSP), portable game devices, and DMB receivers, and moreover, the touch screen method is used for various monitors of devices such as a navigation device, an industrial terminal, a laptop computer, a financial automatic machine, a game device, and also as an input method for various electronic devices even up to various home electronic appliances such as a refrigerator, a microwave oven, or a washing machine.

In addition, with the development of digital contents, virtual experience using a digital device is being attempted in various fields. Also, with the development of the touch input method, a user may input various touch operations such as a drag, a flick, a swipe, or pinching, on a device. As various touch operations for a device are enabled, the sense of reality that a user feels with respect to an event that occurs in response to an operation input to the device has increased. Accordingly, a virtual experience program using a touch-screen type device is tried in various fields.

A computer readable recording medium having embodied thereon an executable program for performing a method of operating a touch screen device according to various embodiments is suggested.

### SUMMARY

One or more embodiments of the present invention include a method of performing an event action by using a touch screen device based on an operation gesture input by using a second operation tool within an operation area determined by a first operation tool that is contacting a touch panel, and the touch screen device according to various embodiments.

Also, one or more embodiments of the present invention include a method of controlling a touch screen device, whereby a current screen that is being operated by using a first operation tool and a second operation tool in a first device is transmitted to an external display device, so that the touch screen device performs an event action upon sensing the same operation gesture being performed by the first and second operation tools in an external display device, and the touch screen device according to various embodiments.

Additional aspects will be set forth in part in the description which follows and, in part, will be apparent from the description, or may be learned by practice of the presented embodiments.

According to one or more embodiments of the present invention include a method of operating a touch screen device, the method comprising: identifying a first operation tool based on contact by the first operation tool, the contact being sensed on the touch screen device; setting an operation area on the touch screen device based on an area designated by the contact by the first operation tool; identifying a second operation tool based on access by the second operation tool, the access being sensed on the touch screen device; sensing an operation gesture of the second operation tool within the operation area by using the second operation tool, wherein the second operation tool moves on the first operation tool and the first operation tool is in contact with the touch screen device; and performing an action corresponding to the sensed operation gesture of the second operation tool from among actions that are previously registered in an interaction database (DB) of the touch screen device.

According to one or more embodiments of the present invention include a method of operating a touch screen device, the method comprising: wherein the identifying a first operation tool comprises determining a position where the first operation tool contacts the touch screen device, by using an electrostatic sensor of the touch screen device, wherein the identifying a second operation tool comprises determining an input position of the second operation tool by using an electromagnetic induction sensor of the touch screen device.

According to one or more embodiments of the present invention include a method of operating a touch screen device, the method comprising: wherein the identifying a first operation tool comprises identifying the first operation tool based on a sensed contacting state of the first operation tool, wherein the sensed contacting state of the first operation tool is from among identification information of operation tools registered with an operation tool register DB of the interaction DB, wherein the setting an operation area on the touch screen device comprises determining an operation area of the identified first operation tool based on form information of operation tools that are previously registered with the operation tool register DB in the operation tool operation area, wherein the identification information comprises at least one of a number of contact points of the first operation tool, a form of each of the contact points, a distance between the contact points, and a surface area of each of the contact points.

According to one or more embodiments of the present invention include a method of operating a touch screen device, the method comprising: wherein the identifying a second operation tool comprises identifying the second operation tool based on a sensed access state of the second operation tool from among identification information of operation tools previously registered with an operation tool register DB of the interaction DB, wherein the identification information comprises at least one of a sensitivity of pressing an auxiliary button of the second operation tool and a release sensitivity of the auxiliary button of the second operation tool.

According to one or more embodiments of the present invention include a method of operating a touch screen device, the method comprising: wherein the identifying a first operation tool comprises: storing, in an operation tool register DB, identification information of the first operation tool including at least one of a number of contact points of the first operation tool, a form of each of the contact points, a distance between the contact points, and a surface area of each of the contact points, which are stored in the interaction DB; and storing information of an operation area determined based on a form of the first operation tool in the operation tool register DB.

According to one or more embodiments of the present invention include a method of operating a touch screen device, the method comprising: wherein the identifying a second operation tool comprises: storing identification information of the second operation tool including at least one of a sensitivity of pressing an auxiliary button of the second operation tool and a release sensitivity of the auxiliary button of the second operation tool, in an operation tool register DB; and storing operation information of the second operation tool including at least one of a contact sensitivity or a release sensitivity of a contacting portion of the second operation tool and a distance between the contacting portion and the touch screen device, in the operation tool register DB.

According to one or more embodiments of the present invention include a method of operating a touch screen device, the method comprising: wherein the interaction DB includes information about an action corresponding to an operation gesture of at least one of the first and second operation tools, wherein the operation gesture of the at least one of the first and second operation tools is a single, previously set input or a set of a series of previously set inputs.

According to one or more embodiments of the present invention include a method of operating a touch screen device, the method comprising: wherein the performing an operation corresponding to the sensed operation gesture of the second operation tool comprises determining an event action corresponding to a series of operation gestures which are input by using at least one of the first and second operation tools, from among the event actions that are previously registered in the interaction DB.

According to one or more embodiments of the present invention include a method of operating a touch screen device, the method further comprising executing an application for performing an event determined based on an operation gesture of at least one of the first and second operation tools, wherein the performing an operation corresponding to a sensed operation gesture of the second operation tool comprises: mapping information about a virtual operation area defined in an application installed in the touch screen device to an event corresponding to an operation gesture of the at least one of the first and second operation tools, to the event actions previously registered with the interaction DB; and performing, when a current operation gesture of the second operation tool is sensed within the virtual operation area as the application is executed, an action of an event corresponding to the current operation gesture.

According to one or more embodiments of the present invention include a method of operating a touch screen device, the method comprising: wherein the performing an action corresponding to the sensed operation gesture of the second operation tool comprises displaying a result screen generated by the performing of the action, on the touch screen device.

According to one or more embodiments of the present invention include a method of operating a touch screen device, the method comprising: wherein the performing an action corresponding to the sensed operation gesture of the second operation tool comprises: receiving an output request which has been submitted to an external device; transmitting image data about a current display screen of the touch screen device to the external device, based on the output request; displaying a virtual operation area of the first operation tool on the touch screen device; and transmitting information about a position and a form of the virtual operation area of the first operation tool, to the external device, wherein when the current display screen and the virtual operation area are displayed on the external device, an operation gesture is sensed within the virtual operation area by using an operation tool of the external device.

According to one or more embodiments of the present invention include a method of operating a touch screen device, the method further comprising: receiving activity information including user identification information, lesson identification information, activity identification information, and activity page identification information, from each of a plurality of touch screen devices in which a same application is installed; displaying an activity list including icons indicating activities and an activity page corresponding to the activity list, on the touch screen device and displaying, on each of the icons indicating the activities, a number indicating how many touch screen devices are displaying on each icon among the icons an activity from among the plurality of touch screen devices; and displaying, when an input about the number is received, activity information of a user of a touch screen device that is displaying the activity page corresponding to the activity information of the user from among the touch screen devices.

According to one or more embodiments of the present invention include a method of operating a touch screen device, the method further comprising transmitting activity information including user identification information, lesson identification information, activity identification information, and activity page identification information, to a management device from among a plurality of touch screen devices in which a same application is installed.

According to one or more embodiments of the present invention include a touch screen device, comprising: a touch screen unit that includes a display unit and a touch panel for outputting a display screen by converting image data to an electrical image signal; a first operation tool sensing unit that senses contact by a first operation tool on the touch screen device and determines a position at which the first operation tool contacts the touch screen device; a second operation tool sensing unit that senses access by a second operation tool on the touch screen and determines an input position of the second operation tool; an operation action management unit that determines an action corresponding to an operation gesture of the second operation tool sensed in an operation area by the second operation tool, which moves on the first operation tool, from among actions that are previously registered in an interaction database (DB) of the touch screen device, and that outputs a control signal so that the action is performed; and a network unit that transmits or receives data to or from an external device.

According to one or more embodiments of the present invention include a touch screen device, comprising: wherein the first operation tool sensing unit determines a position where the first operation tool contacts the touch screen device by using an electrostatic sensor of the touch screen device, and the second operation tool sensing unit determines an input position of the second operation tool by using an electromagnetic induction sensor of the touch screen device.

According to one or more embodiments of the present invention include a touch screen device, comprising: wherein the operation action management unit determines an operation area of the identified first operation tool based on a sensed contacting state of the first operation tool, wherein the sensed contacting state of the first operation tool is from among identification information of previously registered operation tools, and determines an operation area of the identified first operation tool based on form information of the previously registered operation tools, wherein the identification information comprises at least one of a number of contact points of the first operation tool, a form of each of the contact points, a distance between the contact points, and a surface area of each of the contact points.

According to one or more embodiments of the present invention include a touch screen device, comprising: wherein the operation action management unit identifies the second operation tool based on a sensed access state of the second operation tool from among identification information of operation tools that are registered with the interaction DB, wherein the identification information comprises at least one of a sensitivity of pressing an auxiliary button of the second operation tool and a release sensitivity of the auxiliary button of the second operation tool.

According to one or more embodiments of the present invention include a touch screen device, comprising: wherein the operation action management unit stores identification information of the first operation tool including at least one of a number of contact points of the first operation tool, a form of each of the contact points, a distance between the contact points, and a surface area of each of the contact points, wherein information about an operation area determined based on a form of the first operation tool is stored in the operation tool register DB.

According to one or more embodiments of the present invention include a touch screen device, comprising: wherein the operation action management unit stores the identification information of the second operation tool including at least one of a sensitivity of pressing an auxiliary button of the second operation tool and a sensitivity of releasing the auxiliary button of the second operation tool, in an operation tool register DB, and operation information of the second operation tool including at least one of a contact sensitivity or a release sensitivity of a contacting portion of the second operation tool and a distance between the contacting portion and the touch screen device, in the operation tool register DB.

According to one or more embodiments of the present invention include a touch screen device, comprising: wherein the interaction DB includes information about an action corresponding to an operation gesture of at least one of the first and second operation tool, wherein the operation gesture of the at least one of the first and second operation tools is a single, previously set input or a set of a series of previously set inputs.

According to one or more embodiments of the present invention include a touch screen device, comprising: wherein the operation action management unit determines an event action corresponding to a series of operation gestures which are input by using at least one of the first and second operation tools, from among event actions that are previously registered in the interaction DB.

According to one or more embodiments of the present invention include a touch screen device, comprising: further comprising an application executing unit that installs and executes an application, wherein the operation action management unit maps information about a virtual operation area defined in the application to information about an event corresponding to an operation gesture of at least one of the first and second operation tools, to the event actions previously registered with the interaction DB; and determining, when a current operation gesture of the second operation tool is sensed within the virtual operation area as the application executing unit executes the application, event actions corresponding to the current operation gesture.

According to one or more embodiments of the present invention include a touch screen device, comprising: wherein the touch screen unit displays a result screen generated by the performing of the action determined by using the operation action management unit, on the touch screen unit.

According to one or more embodiments of the present invention include a touch screen device, comprising: wherein the touch screen unit displays a virtual operation area of the first operation tool on a current display screen that is transmitted to the external device, based on an output request which has been submitted to the external device, wherein the network unit transmits image data about the current display screen of the touch screen device and information about a position and a form of the virtual operation area of the first operation tool, to the external device, based on the output request which has been submitted to the external device, wherein when the current display screen and the virtual operation area are displayed on the external device, an operation gesture performed while using an operation tool of the external device is sensed within the virtual operation area.

According to one or more embodiments of the present invention include a touch screen device, comprising: wherein the network unit receives activity information including user identification information, lesson identification information, activity identification information, and activity page identification information from each of a plurality of touch screen devices in which a same application is installed, wherein the touch screen unit displays an activity list including icons indicating activities and a current screen, and displays, on each of the icons indicating the activities, a number indicating how many touch screen devices are displaying a current activity page from among the plurality of touch screen devices, wherein the touch screen unit displays activity information of a user of a touch screen device that is displaying the current activity page from among the touch screen devices based on an input about the number.

According to one or more embodiments of the present invention include a touch screen device, comprising: wherein the network unit transmits activity information including user identification information, lesson identification information, activity identification information, and activity page identification information of a current touch screen device from among a plurality of touch screen devices in which a same application is installed, to a management device.

According to one or more embodiments of the present invention include a method of operating a touch screen device, the method comprising: identifying a first operation tool based on contact by the first operation tool, the contact being sensed on a touch screen; and setting an operation area on the touch screen based on an area designated by the contact by the first operation tool, wherein the identifying of a first operation tool comprises identifying based on a pattern formed of positions of a plurality of contact points arranged on the sensed first operation tool.

According to one or more embodiments of the present invention include a method of operating a touch screen device, the method comprising: wherein the identifying a first operation tool comprises determining a position where the first operation tool contacts the touch screen device, by using an electrostatic sensor of the touch screen device.

According to one or more embodiments of the present invention include a method of operating a touch screen device, the method comprising: wherein the identifying a first operation tool comprises identifying the first operation tool based on a sensed contacting state of the first operation tool, wherein the sensed contacting state of the first operation tool is from among identification information of operation tools registered with an operation tool register DB of the interaction DB, wherein the setting an operation area on the touch screen device comprises determining an operation area of the identified first operation tool based on form information of operation tools that are previously registered with the operation tool register DB in the operation tool operation area, wherein the identification information comprises at least one of a number of contact points of the first operation tool, a form of each of the contact points, a distance between the contact points, and a surface area of each of the contact points.

According to one or more embodiments of the present invention include a method of operating a touch screen device, the method comprising: wherein the plurality of contact points arranged on the first operation tool are located around a contact point having a previously set form from among the contact points of the first operation tool, and are expressed as a combination of two-dimensional coordinate values.

According to one or more embodiments of the present invention include a method of operating a touch screen device, the method comprising: wherein the identifying a first operation tool comprises: storing, in an operation tool register DB, identification information of the first operation tool including at least one of a number of contact points of the first operation tool, a form of each of the contact points, a distance between the contact points, and a surface area of each of the contact points, which are stored in the interaction DB; and storing information of an operation area determined based on a form of the first operation tool in the operation tool register DB.

According to one or more embodiments of the present invention include a method of operating a touch screen device, the method comprising: wherein the setting an operation area on the touch screen comprises setting the operation area based on a rotational state of a contact point having the previously set form from among the contact points of the first operation tool.

According to one or more embodiments of the present invention include a method of operating a touch screen device, the method further comprising storing in the touch screen device a content displayed on the touch screen and corresponding to the operation area set on the touch screen.

According to one or more embodiments of the present invention include a method of operating a touch screen device, the method further comprising transmitting the stored content to another device.

According to one or more embodiments of the present invention include a method of operating a touch screen device, the method further comprising requesting information corresponding to the stored content from at least one another device.

According to one or more embodiments of the present invention include a method of operating a touch screen device, the method further comprising: identifying a second operation tool based on access by the second operation tool, the access being sensed on the touch screen device; sensing an operation gesture of the second operation tool within the operation area by using the second operation tool, wherein the second operation tool moves on the first operation tool and the first operation tool is in contact with the touch screen device; and performing an action corresponding to the sensed operation gesture of the second operation tool from among actions that are previously registered in an interaction database (DB) of the touch screen device.

According to one or more embodiments of the present invention include a method of operating a touch screen device, the method comprising: wherein the identifying the second operation tool comprises determining an input position of the second operation tool of the second operation tool by using at least one of an electromagnetic induction sensor and a capacitive sensor of the touch screen device.

According to one or more embodiments of the present invention include a method of operating a touch screen device, the method comprising: wherein the identifying the second operation tool comprises identifying the second operation tool based on an access state of the sensed second operation tool from among identification information that is previously registered with an operation tool register DB of the interaction DB, wherein the identification information comprises at least one of a sensitivity of pressing an auxiliary button of the second operation tool and a release sensitivity of the auxiliary button.

According to one or more embodiments of the present invention include a method of operating a touch screen device, the method comprising: wherein the identifying the second operation tool comprises: storing identification information of the second operation tool including at least one of a sensitivity of pressing an auxiliary button of the second operation tool and a release sensitivity of the auxiliary button of the second operation tool, in an operation tool register DB; and storing operation information of the second operation tool including at least one of a contact sensitivity or a release sensitivity of a contacting portion of the second operation tool and a distance between the contacting portion and the touch screen device, in the operation tool register DB.

According to one or more embodiments of the present invention include a method of operating a touch screen device, the method comprising: wherein the performing an operation corresponding to an operation gesture of the second operation tool comprises determining an event action corresponding to a series of operation gestures which are input by using at least one of the first and second operation tools, from among the event actions that are previously registered in the interaction DB.

According to one or more embodiments of the present invention include a method of operating a touch screen device, the method further comprising executing an application for performing an event determined based on an operation gesture of at least one of the first and second operation tools, wherein the performing an operation corresponding to a sensed operation gesture of the second operation tool comprises: mapping information about a virtual operation area defined in an application installed in the touch screen device to an event corresponding to an operation gesture of the at least one of the first and second operation tools, to the event actions previously registered with the interaction DB; and performing, when a current operation gesture of the second operation tool is sensed within the virtual operation area as the application is executed, an action of an event corresponding to the current operation gesture.

According to one or more embodiments of the present invention include a method of operating a touch screen device, the method comprising: wherein the performing an action corresponding to the sensed operation gesture of the second operation tool comprises displaying a result screen generated by the performing of the action, on the touch screen device.

According to one or more embodiments of the present invention include a method of operating a touch screen device, the method comprising: wherein the performing an action corresponding to the sensed operation gesture of the second operation tool comprises: receiving an output request which has been submitted to an external device; transmitting image data about a current display screen of the touch screen device to the external device, based on the output request; displaying a virtual operation area of the first operation tool on the touch screen device; and transmitting information about a position and a form of the virtual operation area of the first operation tool, to the external device, wherein when the current display screen and the virtual operation area are displayed on the external device, an operation gesture is sensed within the virtual operation area by using an operation tool of the external device.

According to one or more embodiments of the present invention include a method of operating a touch screen device, the method further comprising: receiving activity information including user identification information, lesson identification information, activity identification information, and activity page identification information, from each of a plurality of touch screen devices in which a same application is installed; displaying an activity list including icons indicating activities and an activity page corresponding to the activity list, on the touch screen device and displaying, on each of the icons indicating the activities, a number indicating how many touch screen devices are displaying on each icon among the icons an activity from among the plurality of touch screen devices; and displaying, when an input about the number is received, activity information of a user of a touch screen device that is displaying the activity page corresponding to the activity information of the user from among the touch screen devices.

According to one or more embodiments of the present invention include a method of operating a touch screen device, the method further comprising transmitting activity information including user identification information, lesson identification information, activity identification information, and activity page identification information, to a management device from among a plurality of touch screen devices in which a same application is installed.

According to one or more embodiments of the present invention include a touch screen device, comprising: a touch screen unit that includes a display unit and a touch panel for outputting a display screen by converting image data to an electrical image signal; a first operation tool sensing unit that senses contact by a first operation tool on the touch screen device and determines a position at which the first operation tool contacts the touch screen device; an operation action management unit that determines an action corresponding to movement of the first operation tool, from among actions that are previously registered in an interaction database (DB) of the touch screen device, and that outputs a control signal so that the action is performed; and a network unit that transmits or receives data to or from an external device, wherein the first operation tool sensing unit identifies the first operation tool based on a pattern formed of positions of a plurality of contact points arranged on the sensed first operation tool.

According to one or more embodiments of the present invention include a touch screen device, comprising: a touch screen unit that includes a display unit and a touch panel for outputting a display screen by converting image data to an electrical image signal; a first operation tool sensing unit that senses contact by a first operation tool on the touch screen device and determines a position at which the first operation tool contacts the touch screen device; a second operation tool sensing unit that senses access by a second operation tool on the touch screen and determines an input position of the second operation tool; an operation action management unit that determines an action corresponding to an operation gesture of the second operation tool sensed in an operation area by the second operation tool, which moves on the first operation tool, from among actions that are previously registered in an interaction database (DB) of the touch screen device, and that outputs a control signal so that the action is performed; and a network unit that transmits or receives data to or from an external device, wherein the first operation tool sensing unit identifies the first operation tool based on a pattern formed of positions of a plurality of contact points arranged on the sensed first operation tool.

According to one or more embodiments of the present invention include a non-transitory computer readable recording medium having embodied thereon a program for executing the method of one of above-mentioned.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram illustrating a touch screen device according to various embodiments;

FIG. 2 illustrates operation tools according to various embodiments;

FIG. 3 illustrates guide operation tools according to various embodiments;

FIGS. 4 through 6 illustrate a sensing method of an operation tool according to various embodiments;

FIG. 7 is a flowchart illustrating a method of identifying an operation tool according to various embodiments;

FIGS. 8A and 8B illustrate identification information and an operation area of a guide operation tool according to an embodiment;

FIG. 9 is a flowchart illustrating a method of registering guide operation tools according to various embodiments;

FIG. 10 is a flowchart illustrating a method of identifying an operation tool according to an embodiment;

FIG. 11 is a flowchart illustrating a method of operating an operation tool according to various embodiments;

FIG. 12 is a flowchart illustrating a method of registering operation tool according to various embodiments;

FIGS. 13A, 13B, 13C and 13D illustrate a rotational state of an operation tool according to various embodiments;

FIGS. 14A, 14B, 14C and 14D illustrate a method of operating a touch screen device by using a rotational state of an operation tool according to various embodiments;

FIG. 15 illustrates an operation of storing a content corresponding to an operation area according to various embodiments;

FIGS. 16, 17, and 18 illustrate an operation area according to various embodiments;

FIG. 19 is a flowchart illustrating a method of mapping an operation action management unit to an application, according to various embodiments;

FIG. 20 illustrates an operation in which actions of a touch screen device according to various embodiments and an external device are shared;

FIG. 21 illustrates a structure of a touch screen device and an auxiliary operation tool according to various embodiments;

FIG. 22 illustrates a virtual experiment screen of an experiment application by using a touch screen device and a flowchart of a virtual experiment method, according to an embodiment;

FIG. 23 is a flowchart illustrating a virtual experiment method according to an embodiment;

FIG. 24 illustrates a virtual microscope experiment screen of an experiment application, according to an embodiment;

FIG. 25 illustrates a virtual experiment navigation screen of an experiment application, according to an embodiment of the present invention;

FIG. 26 is a flowchart illustrating a method of operating a virtual experiment navigation device of an experiment application, according to an embodiment;

FIG. 27 illustrates an operation of monitoring activities of an experiment application by a plurality of touch screen devices, according to an embodiment;

FIG. 28 illustrates a monitoring screen of a management terminal from among a plurality of mapped touch screen devices, according to an embodiment;

FIG. 29 illustrates a monitoring screen of a management terminal from among a plurality of mapped touch screen devices, according to an embodiment; and

FIG. 30 illustrates a structure of a touch screen device for use of an application, according to an embodiment.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

The attached drawings for illustrating exemplary embodiments of the present invention are referred to in order to gain a sufficient understanding of the present invention, the merits thereof, and the objectives accomplished by the implementation of the present invention. Hereinafter, the present invention will be described in detail by explaining exemplary embodiments of the invention with reference to the attached drawings. Like reference numerals in the drawings denote like elements.

In the present specification, when a constituent element “connects” or is “connected” to another constituent element, the constituent element contacts or is connected to the other constituent element not only directly but also electrically through at least one of other constituent elements interposed therebetween. Also, when a part may “include” a certain constituent element, unless specified otherwise, it may not be construed to exclude another constituent element but may be construed to further include other constituent elements.

Also, in the present specification, an input by an operation tool may include at least one of a touch input, a button input, an Air input, and a multimodal input, but is not limited thereto.

Also, a “touch input” in the present specification refers to a touch gesture of an operation tool performed on a touch screen in order to input a control command to a touch screen device 100. Examples of the touch input include a tap, a touch & hold, dragging, panning, flicking, and a drag and drop, but the touch input is not limited thereto.

Also, a “button input” in the present specification may refer to an input by a user for controlling the touch screen device 100 by using a physical button attached to the touch screen device 100 or an operation tool.

Also, an “Air input” in the present specification refers to a user input conducted in the air above a surface of a screen in order to control the touch screen device 100. For example, an “Air input” may include an input of pressing an auxiliary button of an operation tool or moving an operation tool without a user touching a surface of the touch screen device 100. The touch screen device 100 may sense a previously set Air input by using, for example, a magnetic sensor.

Also, a “multimodal input” in the present specification refers to combination of at least two input methods. For example, the touch screen device 100 may receive a touch input by a first operation tool and an Air input by a second operation tool. Also, the touch screen device 100 may receive a touch input by a first operation tool and a button input by a second operation tool.

Also, in the present specification, a change in an input mode refers to changing which unit or units receive a user input with respect to a mobile device and changing an action which corresponds to the received user input. For example, when an input mode of a mobile device is changed, the mobile device may activate or inactivate some of sensors that receive a user input. Also, for example, depending on an input mode at the time of a user input, a mobile device may interpret the user input differently, and conduct different actions according to the input modes.

Also, in the present specification, an “application” refers to a series of computer program sets that are designed to perform a predetermined task. The application according to the present specification may be various. Examples of the application are a learning application, a virtual experiment application, a game application, a video replay application, a map application, a memo application, a calendar application, a phonebook application, a broadcasting application, a sports assisting application, a payment application, a picture folder application, but the application is not limited thereto.

Also, in the present specification, an “object” refers to a still image, a video, or a text indicating predetermined information and may be displayed on a screen of the touch screen device 100. An object may include, for example, a user interface, a result of executing an application, a result of executing contents, a list of contents, and icons, but the object is not limited thereto.

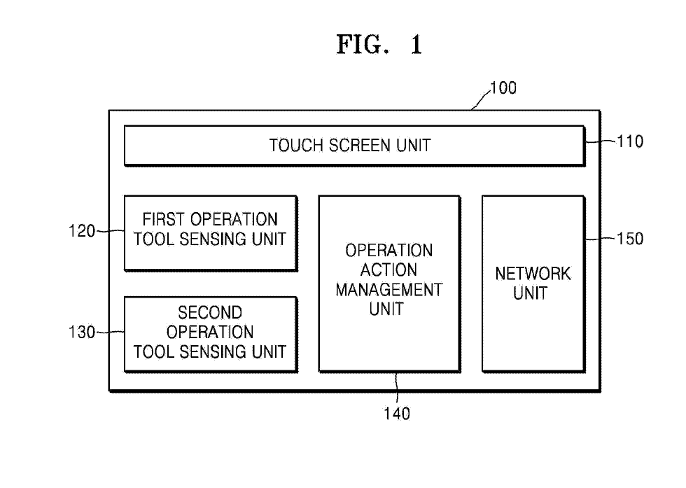

FIG. 1 is a block diagram illustrating a touch screen device 100 according to various embodiments. The touch screen device 100 according to various embodiments includes a touch screen unit 110, a first operation tool sensing unit 120, a second operation tool sensing unit 130, an operation action management unit 140, and a network unit 150.

The touch screen unit 110 according to various embodiments may be formed of a display unit and a touch panel. The touch panel may be disposed at an upper end or a lower end of the display unit. The touch panel is a component with which a user input according to access by an operation tool or a body portion is sensed. The display unit is a component that converts image data to an electrical image signal to output a display screen. However, in the present specification, an operation or an action on the touch screen unit 110 may also be understood as an operation or an action with respect to a touch panel.

The first operation tool sensing unit 120 according to various embodiments may determine a contact position of a first operation tool when contact by the first operation tool is sensed on the touch screen unit 110. The contact position may be determined as an input position where a user command is input on the touch screen unit 110.

The second operation tool sensing unit 130 according to various embodiments may determine an input position of a second operation tool when access by the second operation tool is sensed.

The first operation tool sensing unit 120 may include an electrostatic sensor to sense a change in electrostatic capacitance of a portion of a below a surface of the touch screen unit 110. When the portion of the below the surface of the touch screen unit 110 changes in charge in terms of electrostatic capacitance due to an action of the first operation tool, the first operation tool sensing unit 120 senses a contact of the first operation tool, and may determine an input position of the first operation tool based on a point where the change in the charge is generated.

The second operation tool sensing unit 130 includes a magnetic field sensor and an electromagnetic induction device. When a change is generated in a magnetic field in electromagnetic space above the surface of the touch screen unit 110 generated by the electromagnetic inducting device, the magnetic sensor may sense the change in the magnetic field. The second operation tool sensing unit 130 may sense access or contact by the second operation tool when a change in a magnetic field is generated in the electromagnetic space, and may determine an input position of the second operation tool based on a point where the change in the magnetic field is generated.

In the present specification, a mode of action of using an operation tool for a command input with respect to the touch screen unit 110 is referred to as an operation gesture.

An operation gesture of a first operation tool according to an embodiment may include a contact by the first operation tool on the surface of the touch screen unit 110.

An operation gesture of a second operation tool according to an embodiment may include a contact by the second operation tool with respect to the surface of the touch screen unit 110, an air input action of the second operation tool that is within a vertical distance from a plane of the touch screen unit 110, and an input action of an auxiliary button of the second operation tool.

Moreover, an operation gesture may be a single input action of at least one of the first and second operation tools or a series of input actions of at least one operation tool.

In addition, the second operation tool sensing unit 130 may sense an operation gesture of a second operation tool that is moved along a first operation tool. The second operation tool sensing unit 130 may sense an operation gesture performed with the second operation tool within an operation area determined by a contact by the first operation tool.

The operation action management unit 140 according to various embodiments includes an interaction database (DB) in which actions to be performed in the touch screen device 100 are registered, according to operation gestures performed with the respective operation tools.

An interaction object included in the interaction DB according to various embodiments may include information about an action corresponding to each operation gesture of an operation tool.

The operation action management unit 140 according to various embodiments may determine an action corresponding to an operation gesture of the first operation tool sensed by using the first operation tool sensing unit 120 or an operation gesture of the second operation tool sensed by the second operation tool sensing unit 130 from among actions that are previously registered in the interaction DB. The operation action management unit 140 may transmit a control signal according to which the determined action is requested to be conducted, to a corresponding operating unit.

While the first operation tool sensing unit 120 is sensing an input of the first operation tool on the touch screen unit 110, when an operation gesture of the second operation tool is sensed within an operation area that is determined by the first operation tool, by using the second operation tool sensing unit 130, the operation action management unit 140 may determine that there is an input by the second operation tool on the first operation tool.

In the interaction DB according to an embodiment, information about actions corresponding to the operation gesture of the second operation tool sensed within the operation area of the first operation tool may be registered.

The operation action management unit 140 may determine, from among the actions that are previously stored in the interaction DB, an action corresponding to an operation gesture of the second operation tool on the first operation tool or to an operation gesture of the second operation tool within the operation area.

The touch screen device 100 according to various embodiments may further include an application executing unit (not shown) that installs and executes an application. An application may provide information about various event actions that are performed based on a user input made via an input unit of the touch screen device 100, that is, a first operation tool or a second operation tool.

When an application is executed, the operation action management unit 140 according to an embodiment may interwork information about a virtual operation area defined in the application and an event corresponding to an operation gesture of at least one operation tool, to the interaction DB and an operation tool register DB of the operation action management unit 140.

An application may also define an event action corresponding to an input of an operation tool with respect to a virtual operation area. When an application executing unit (not shown) executes an application, and a current operation gesture of the second operation tool is sensed within a virtual operation area, the operation action management unit 140 may determine actions of an event corresponding to the current operation gesture.

The touch screen device 100 according to various embodiments may also display a screen showing a result of conducting one of the actions determined by the operation action management unit 140, on the touch screen unit 110.

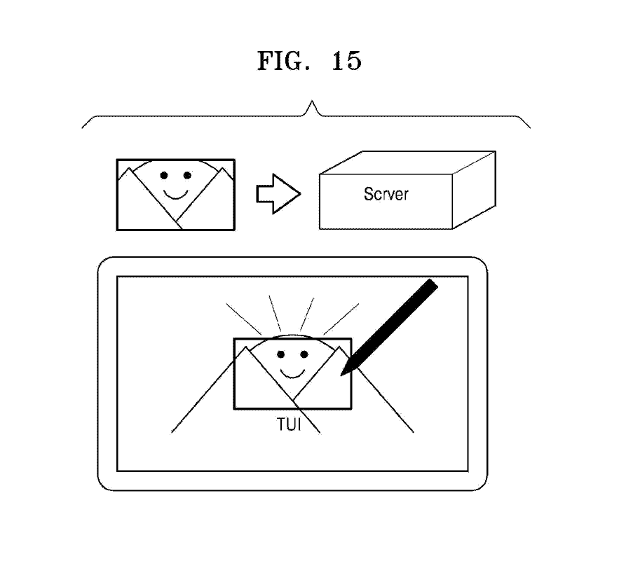

The network unit 150 according to various embodiments may transmit or receive data to or from an external device. Information about a display screen or an event action being reproduced on the touch screen device 100 may be transmitted to and shared with an external device. Various examples of data sharing between the touch screen device 100 and the external device will be described later with reference to FIGS. 15, 20, 27, and 28.

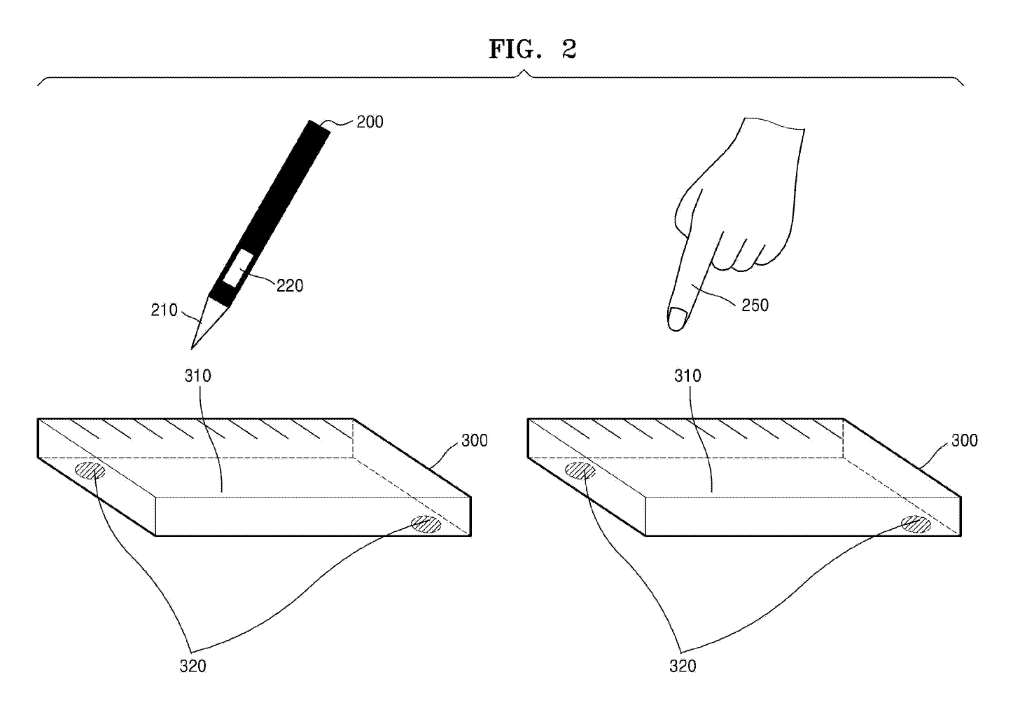

FIG. 2 illustrates operation tools according to various embodiments.

The touch screen device 100 may be controlled according to a user input by using a plurality of operation tools which are sensed using different methods. For example, a guide operation tool 300 and an auxiliary operation tool 200 may be used as operation tools for the touch screen device 100.

The auxiliary operation tool 200 is formed of a body and a contact portion 210, and an auxiliary button 220 is formed on the body of the auxiliary operation tool 200. The contact portion 210 may be a physical tool via which a pressure is applied to a touch panel of the touch screen device 100. Also, a position of the contact portion 210 sensed by using an electrostatic sensor or a magnetic sensor may be determined as a point where the auxiliary operation tool 200 provides an input. An operation gesture may be distinguished by a degree of sensitivity that the contacting portion 210 is pressed against a touch panel or the number of times the contacting portion 210 touches the touch panel.

The auxiliary button 220 is another input unit of the auxiliary operation tool 200, and operation gestures such as a button press, a repeated button press, the number of times a button is pressed during the repeated button press, or a release of the button may be distinguished.

Accordingly, as an operation gesture of the contacting portion 210 of the auxiliary operation tool 200 and an operation gesture of the auxiliary button 220 are combined in various manners, the operation gesture of the auxiliary operation tool 200 may be further diversified.

As illustrated in FIG. 2B, another example of the auxiliary operation tool 200 may be a body portion 250 of a human body. The touch screen 100 may sense a contact by a human body, and the contact by a human body may be sensed using various methods such as methods using an infrared ray, light, a high frequency, magnetism or capacitance. While the auxiliary operation tool 200 in the form of a stylus pen described above may include the auxiliary button 220 on a body thereof, if the human body functions as the auxiliary operation tool 250, no auxiliary button is included and thus various operation gestures may not be identified in a terminal. Accordingly, various operation gestures may be identified by receiving an input of an auxiliary button that is additionally put on the human body or by sensing a body portion where a contact between bodies is conducted (for example, a sensor that senses a contact between bodies may be included in a touch screen of a terminal so as to sense a variation in contact information that is generated when an index finger, which is used as an auxiliary operation tool, is touched by a thumb).

The guide operation tool 300 may be formed of a guide body portion 310 and at least one contacting portion 320. The guide body portion 310 may be formed of a transparent, semi-transparent or opaque material. The contacting portion 320 may be formed of a material that allows a change in a charge amount of the touch screen unit 110 and may be located at a predetermined position on the guide body portion 310.

While the auxiliary operation tool 200 (or a finger as the auxiliary operation 200) in the form of a pen and the guide operation tool 300 in the form of a ruler are illustrated in FIG. 2, the form of each operation tool is not limited thereto. For example, the guide operation tool 300 may be in the form of a geometrical object such as a sphere, a cylinder or a cone, or a hexahedron or an atypical object such as a star, and the guide operation tool 300 may be any object that includes a contacting portion 320 sufficient enough to cause a change in a charge amount of the touch screen unit 110.

Also, although the contacting portion 320 is located at a position farthest from the guide body portion 310 in FIG. 2, the embodiments of the present invention are not limited thereto. For example, the contacting portion 320 may be formed of any material that may cause a change in a charge amount of the touch screen unit 110, regardless of the number, form, position, distance or the like of the contacting portion 320.

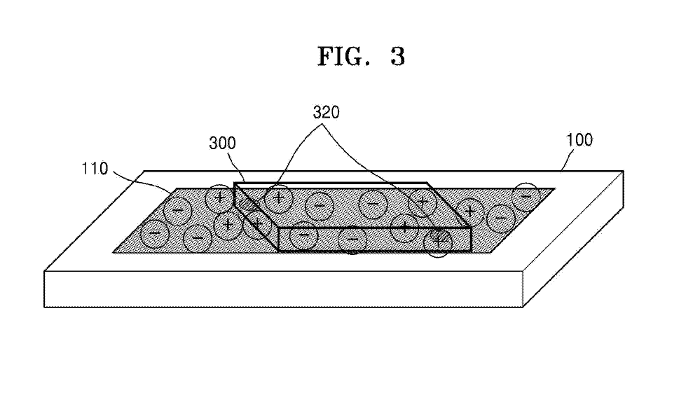

FIG. 3 illustrates a guide operation tool 300 according to various embodiments.

A guide body portion 310 of the guide operation tool 300 which is in the form of a ruler may be formed of a transparent nonconductor, and the contacting portion 320 that is to contact the touch screen unit 110 may be formed of a conductor in which electrostatic charges may form. Also, at least two contacting portions 320 may be connected via a conductor so that charges may be moved to be collected in the contacting portions 320. Thus, if the contacting portion 320 of the guide operation tool 300 contacts the touch screen unit 110, the touch screen unit 110 may sense movement of charges via the contacting portion 320 to determine whether there is a contact. Alternatively, when hand 330 of a user contacts a conductor, the contacting portions 320 may be easily electrostatically charged. The contacting portions 320 may also be respectively located on upper and lower surfaces of the operation tool 300.

The guide operation tool in the form of a regular hexahedron such as a die may also be used. The guide operation tool is a regular non-conductive hexahedron, and one, two, three, four, five, or six contacting portions may be attached on each of six surfaces thereof, or the contacting portions may be disposed on the respective surfaces of the guide operation tool and protrude therefrom. The contacting portions may each be a conductor and may be connected to at least one another contacting portion, and thus, charges may become electrostatic. Accordingly, the touch screen unit 110 may sense a touch operation gesture of the guide operation tool regardless of which of the six surfaces of the guide operation tool is in contact with the touch screen unit 110. Also, as the number of the contacting portions attached on each surface and sensed by the touch screen unit 110 is different, the touch screen unit 110 may also analyze which surface of the guide operation tool is sensed.

Hereinafter, the guide operation tool 300 in the form of a ruler will be used as a first operation tool that manipulates the touch screen device 100. However, the guide operation tool for the touch screen device 100 according to various embodiments is not limited to the guide operation tool 300 in the form of a ruler described above.

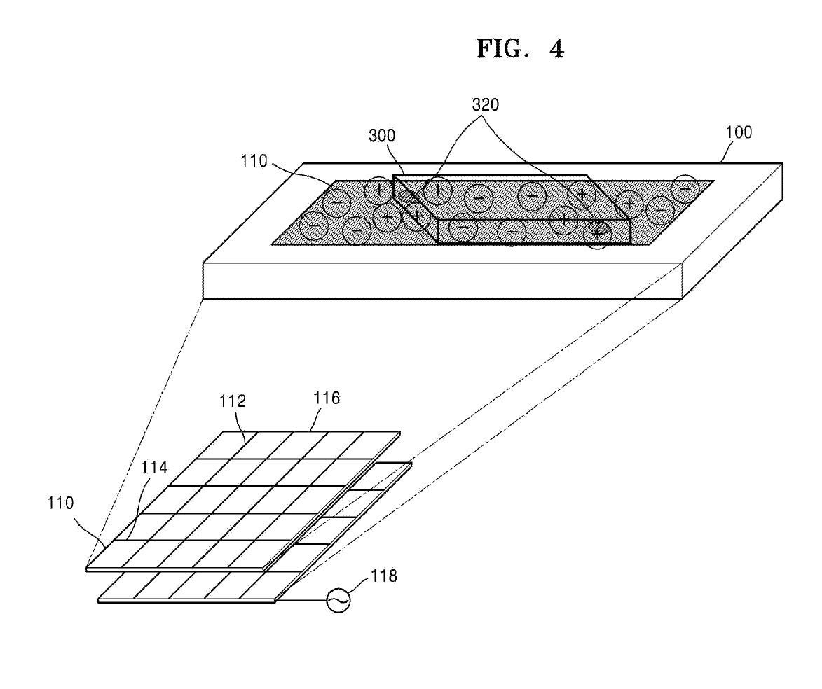

FIGS. 4 through 6 illustrate a sensing method of an operation tool according to various embodiments.

Referring to FIG. 4, charges of a predetermined electrostatic capacity are accumulated in the touch screen unit 110 of the touch screen device 100. When the contacting portion 320 of the guide operation tool 300 touches a surface of the touch screen unit 110, distribution of the charges in the touch panel is varied because (+) charges from among the charges accumulated in the touch panel are collected at a point of the contacting portion 320.

Also, the touch screen unit 110 may include conducting wires 116 that are orthogonal to one another with respect to a vertical line 112 and a horizontal line 114 such that charges move through the conducting wires 116. When a variation value 118 of charges is sensed on the conducting wires that are orthogonal to one another, it may be determined that the guide operation tool 300 is located in a predetermined area of the touch screen unit 110 based on the sensed variation value. Accordingly, an operation area may be determined based on a position of the guide operation tool 300.

An electrostatic sensor of the first operation tool sensing unit 120 may sense a change in a charge amount in the touch panel and determine a position of the contacting portion 320. The operation action management unit 140 may identify the guide operation tool 300 and determine an operation area based on a position, a size, a distance, and a form of the contacting portion 320.

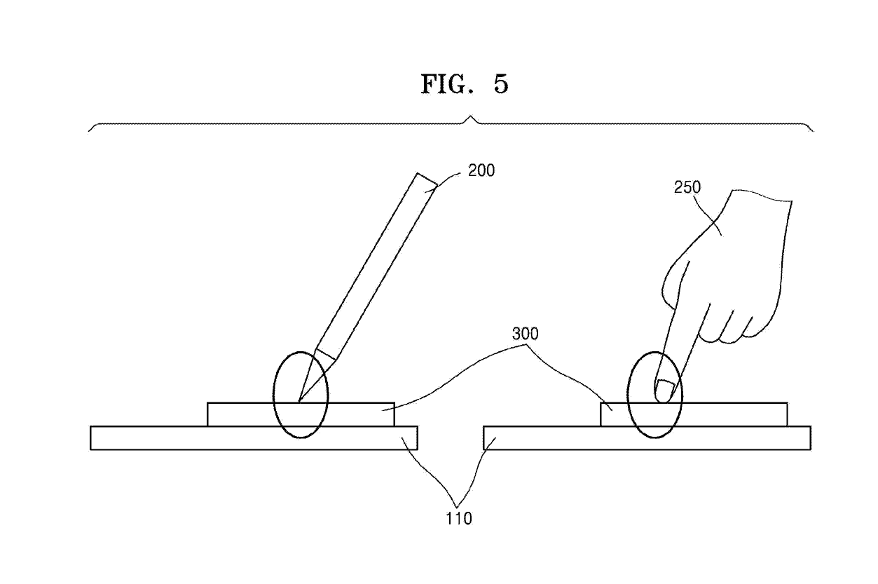

According to the embodiment of FIG. 5, an operation of the auxiliary operation tool 200 or 250 may be sensed on a touch screen on the guide operation tool 300 which is disposed on a touch panel of the touch screen unit 110. Here, an operation of the auxiliary operation tool 200 in the form of a pen on the guide operation tool 300 and the finger type auxiliary operation tool 250 on the guide operation tool 300 may be sensed as different signals on the touch screen unit 110. The touch screen device 100 may determine the sensed two types of signals as the same operation signal.

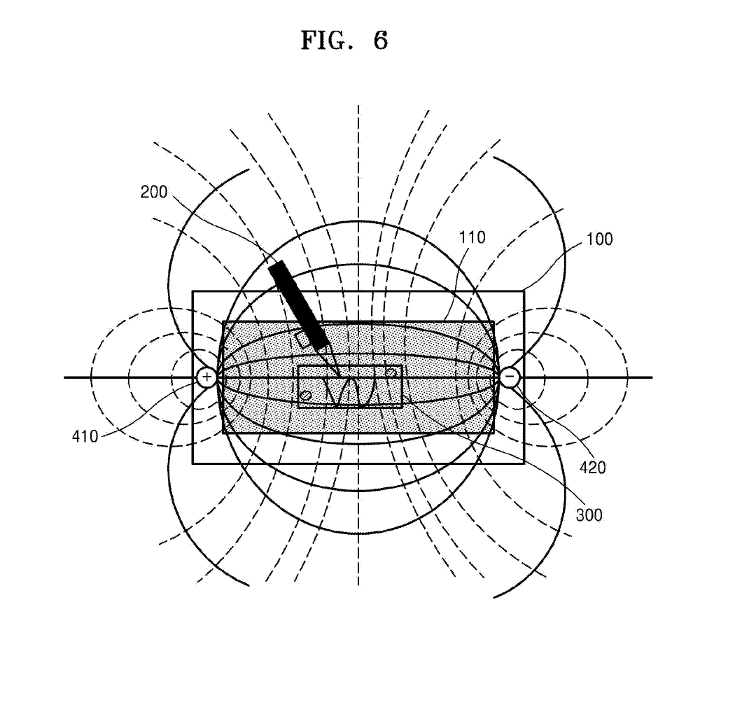

According to the embodiment of FIG. 6, electromagnetic field inducing elements 410 and 420 of the touch screen device 100 may generate a magnetic field on the touch screen unit 110 electrically. As the auxiliary operation tool 200 or 250 moves within a magnetic field, a density or intensity of the magnetic field is varied.

A magnetic field sensor of the second operation sensing unit 130 may sense a variation in a magnetic field on the touch screen unit 110 to determine a position of the second auxiliary operation tool 200 or 250. The operation action management unit 140 may identify the auxiliary operation tool 200 or 250 based on an operating state of the auxiliary button 220.

In addition, while the guide operation tool 300 contacts a surface of the touch screen unit 110 and an operation area is set, as the contacting portion 210 of the auxiliary operation tool 200 or 250 moves on the guide operation tool 300 or within the operation area, an operation gesture may be sensed. At the same time when an electrostatic sensor is sensing a contact by the guide operation tool 300, the magnetic field sensor may sense an action of the second auxiliary operation tool 200 or 250. The operation action management unit 140 may determine a corresponding event action based on operation gestures performed by the contacting portion 210 of the second auxiliary operation tool 200 or 250 and the auxiliary button 220.

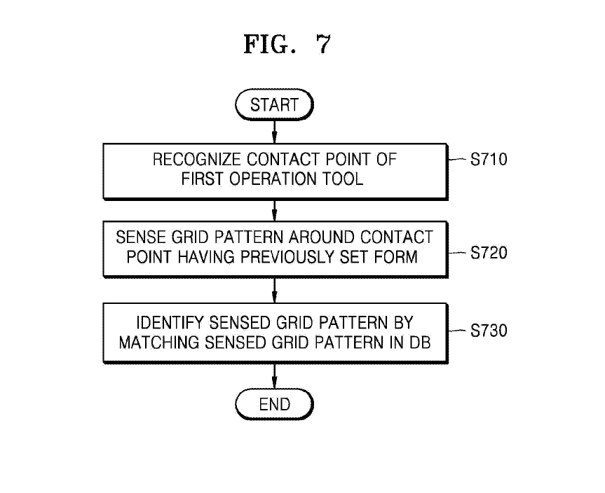

FIG. 7 is a flowchart illustrating a method of identifying an operation tool according to an embodiment.

In operation S710, the touch screen unit 110 of the touch screen device 100 may recognize a contact point of a first operation tool. As described above, contact points of the guide operation tool 300 may be connected to one another via a conductor, and thus, when the guide operation tool 300 contacts the touch screen unit 110, the touch screen unit 110 may sense a variation in charges moving via the contact points, thereby recognizing the contact points of the guide operation tool 300.

In operation S720, from among the touched contact points, the touch screen unit 110 may sense a grid pattern around a contact point in a previously set form. The guide operation tool 300 may have a plurality of contact points, and contact points in a predetermined form may be previously set from aong the contact points. The contact point in a previously set form may be used as identification information that denotes unique information of the guide operation tool 300.

In operation S730, the touch screen device 100 may search an operation tool register database (DB) for the sensed grid pattern and match the grid pattern with the guide operation tool 300 to identify the guide operation tool 300. The operation tool register DB may be a DB inside the touch screen device 100 or an external DB.

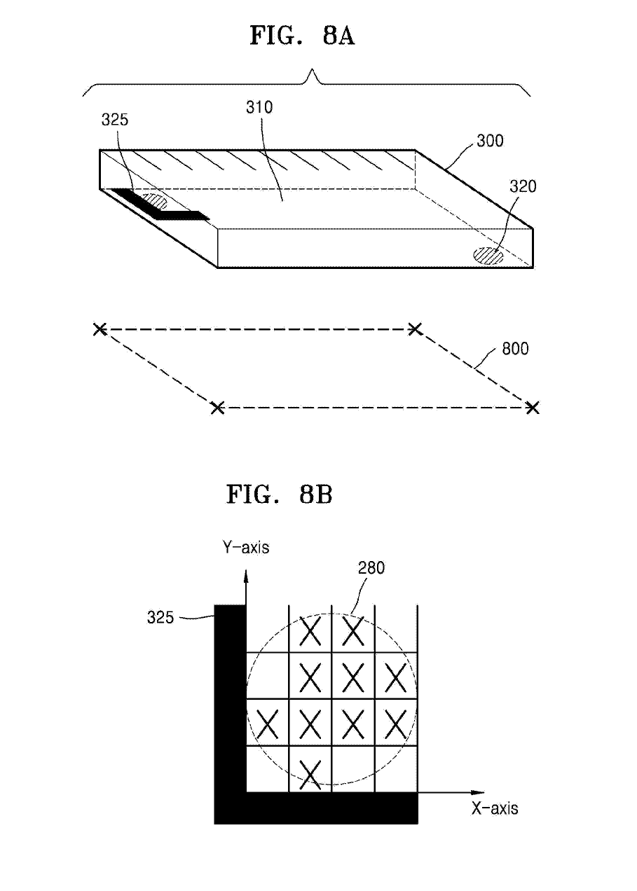

FIGS. 8A and 8B illustrate identification information and an operation area of the guide operation tool 300 according to an embodiment.

As illustrated in FIG. 8A, the guide operation tool 300 may include at least one contacting portion 320 in the guide body portion 310. From among the contacting portions 320, a contacting portion 325 in a previously set form may be included. The contacting portion 325 in a previously set form may generate a different amount of charge movement from the other contacting portions 320, and thus may be identified as a different one from the contacting portions 320. The previously set form may be a two-dimensional or three-dimensional form, and the operation action management unit 140 of the touch screen device 100 may identify form information of the contacting portions 320.

The operation action management unit 140 according to various embodiments may identify the guide operation tool 300 based on a contacting state of the guide operation tool 300. The first operation tool sensing unit 120 may sense a contact by the contacting portion 320 of the guide operation tool 300 on a touch panel of the touch screen unit 110 and may sense, for example, the number, a form, or a surface area of the contacting portion 320 or a distance of between contacting portions 320. The operation action management unit 140 may identify the guide operation tool 300 based on at least one of the number, the form, or the surface area of the contacting portion 320 and the distance between contacting portions 320 of the guide operation tool 300.

That is, identification information of the guide operation tool 300 may include at least one of the number, the form, and the surface area of the contacting portion 320, and the distance between the contacting portions 320. The identification information of the guide operation tool 300 including at least one of the number, the form, and the surface area of the contacting portion 320, and the distance of between contacting portions 320 may be registered in the operation tool register DB of the operation action management unit 140. For example, the distance between contacting portions 320 may be expressed in units of pixels.

Also, regarding the guide operation tool 300 having registered identification information, registered information including at least one of an operation tool ID, a tool type, operation information, and form information may be stored in the operation tool register DB.

The operation information about the guide operation tool 300 indicates information about a type of contact or input of the guide operation tool 300 such that an input operation gesture may be interpreted as a control signal. For example, the operation information of the guide operation tool 300 may include information about an operation pattern, such as the number of times a contact is made, a direction of the contact, sensitivity of the contact, or time of a contact by the guide operation tool 300.

The form information about the guide operation tool 300 may include information about the form of the guide operation tool 300. For example, when the guide operation tool 300 is placed on the touch screen unit 110, coordinates information of four characteristic points, that is, (0, 0), (100, 0), (100, 50), and (0, 50), may be determined as form information.

The form information of the identified guide operation tool 300 may also be used for determining an operation area 800 of the guide operation tool 300. That is, when the guide operation tool 300 is identified based on the operation tool register DB, the operation action management unit 140 may determine the operation area 800 according to the operation tool 300 on the touch screen unit 110 based on the form information previously stored in the operation tool register DB.

Thus, the operation action management unit 140 according to the various embodiments may identify the guide operation tool 300 based on a contacting state of the currently sensed guide operation tool 300 from among identification information of the operation tools that are previously registered in the operation tool register DB, and may determine the operation area 800 of the guide operation tool 300 based on the form information of the previously registered operation tools.

In addition, the operation action management unit 140 according to the various embodiments may identify the auxiliary operation tool 200 based on a state of an access by the currently sensed auxiliary operation tool 200 from among identification information of the operation tools that are previously registered in the operation tool register DB. The auxiliary operation tool 200 is capable of making an air input, in addition to a touch input and an auxiliary button input, and thus, may be identified not only by a touch state but also by an access state. An auxiliary operation tool may also be identified by a touch of the finger 250 beforehand. Identification information of the auxiliary operation tool 200 that is previously registered in the operation tool register DB may include at least one of how hard the auxiliary button 220 of the auxiliary operation tool 200 is pressed and how much the auxiliary button 220 is released. Alternatively, a distance between the touch screen 110 and the contacting portion 210 while the auxiliary button 220 is being pressed may be used as identification information.

When the auxiliary operation tool 200 is identified based on identification information stored in the operation tool register DB, an operation gesture of the auxiliary operation tool 200 may be analyzed based on operation information of the auxiliary operation tool 200 stored in the operation tool register DB. For example, the operation information of the auxiliary operation tool 200 may include at least one of a contacting sensitivity or a release sensitivity of the contacting portion 210 of the auxiliary operation tool 200, a distance between the contacting portion 210 and the touch screen unit 110, the number of times that the auxiliary button 220 is pressed, the period of time of pressing the auxiliary button 220, the number of times that the contacting portion 210 is contacted by the auxiliary operation tool 200, and a period of time that the contacting portion 210 is in contact with the auxiliary operation tool 200.

In order to identify the operation tool sensed by the touch screen device 100 according to the various embodiments, an operation of registering identification information of an operation tool and operation information of the operation tool in an operation tool register DB may be performed in advance.

As illustrated in FIG. 8B, the contacting portion 320 may be the contacting portion 325 in a previously set form, and the contacting portion 325 in a previously set form may be an ‘L’ shape. Hereinafter, the contacting portion 325 will be referred to as an L-shaped contacting portion 325 for convenience of description. The L-shaped contacting portion 325 has a two-dimensional form along an x-axis and a y-axis, and grid coordinates 330 which is a quadrangle including the L-shaped contacting portion 325 on two sides thereof may be disposed. At least one contact point may be arranged on the grid coordinates 330, and positions of contact points may be indicated as two-dimensional coordinates. The touch screen unit 110 may sense the L-shaped contacting portion 325 and contact points that are near the L-shaped contacting portion 325 and may be expressed as two-dimensional coordinates, and thus, the guide operation tool 300 may be identified based on this coordinates information.

The operation action management unit 140 may identify a combination of contact points arranged near the L-shaped contacting portion 325 as a grid pattern. The operation action management unit 140 may identify a guide operation tool corresponding to a grid pattern based on the operation tool register DB, and accordingly, the grid pattern included in the guide operation tool 300 may be unique identification information of the guide operation tool 300.

The grid pattern is arranged around the L-shaped contacting portion 325 for following reasons. An L-shape has a form in which axes in two directions are orthogonal to each other. Thus, when a contacting portion has a form like the L-shaped contacting portion 325, two-dimensional coordinates along the x-axis and the y-axis may be formed. Also, a rotational state of the L-shaped contacting portion 325 may be easily sensed so that a rotational state of the guide operation tool 300 on the touch screen unit 110 may be reflected when determining an operation area. Thus, it is sufficient to set the L-shaped contacting portion 325 having a form in which two-dimensional coordinates are formed and the L-shaped contacting portion 325 is not limited to an L-shape.

Two-dimensional grid coordinates may be formed on the right side of the L-shaped contacting portion 325. The two-dimensional grid coordinates may not have to be necessarily those that are marked outside, and it is sufficient when contact points arranged on the grid coordinates are identified as a single coordinate value.

As illustrated in FIG. 8B, contact points may be arranged around (on the right side of) the L-shaped contacting portion, and the contact points may have a predetermined shape (X-shape). When a point of intersection where an X axis and a Y axis meet is set as (x,y)=(0,0), the contact points arranged in FIG. 8B may be expressed as coordinates. In a first row (y=0) at the bottom, a contact point that may be expressed as (1, 0) is arranged, and in a second row (y=1), contact points that may be expressed as (0,1), (1,1), (2,1), and (3,1) are arranged. In a third row (y=2), contact points that may be expressed as (1,2), (2,2), and (3,2) are arranged, and in a fourth row (y=3), a contact point that may be expressed as (1,3) is arranged. Thus, a grid pattern consisting of a combination of (x,y)=(1,0), (0,1), (1,1), (2,1), (3,1), (1,2), (2,2), (3,2), (1,3) may be formed. If contact points having the above coordinate values are sensed around the L-shaped contacting portion 325, the operation action management unit 140 may search for the grid pattern in the operation tool register DB and match the same with the grid pattern to identify the gird pattern as the unique guide operation tool 300.

As described above, as the grid pattern may be formed of a combination of coordinate values, grid coordinates having a larger x*y size may include information whereby more guide operation tools may be identified. Mathematically, 2^{N*N}−1 grid patterns may be identified by using N*N square grid coordinates.

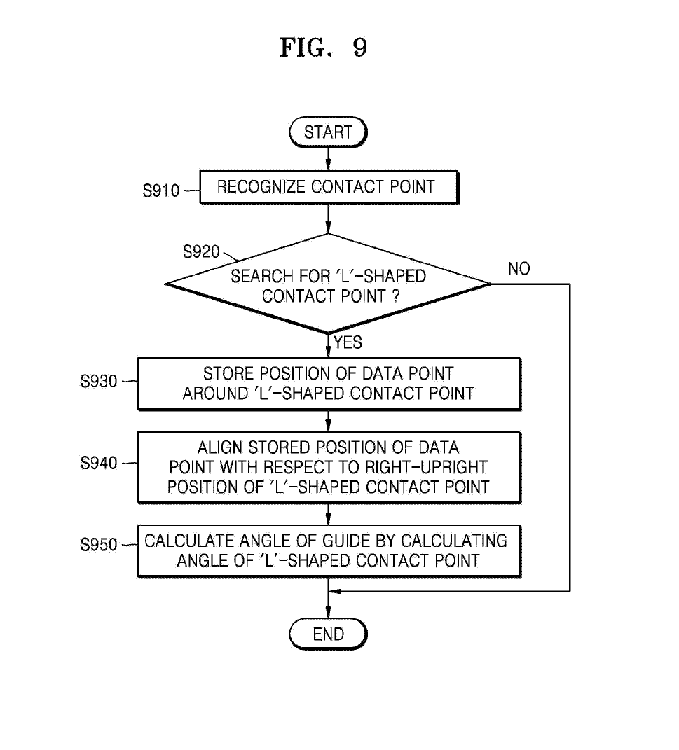

FIG. 9 is a flowchart illustrating a method of registering guide operation tools according to various embodiments. Hereinafter, a contacting portion in a previously set form will be assumed to be an L-shaped contacting portion.

In operation S910, the touch screen unit 110 may recognize a contact point with respect to a guide operation tool. As a variation in a charge amount or a variation in an amount of electromagnetism due to a contact point located in the contacting portion may be sensed by using a sensor embedded in the touch screen device 100, the contact point may be recognized.

In operation S920, an L-shaped contact point may be searched for to sense a position of the L-shaped contacting portion. The L-shaped contacting portion has a form that is distinguished from other contacting portions, and thus may be sensed.

In operation S930, the touch screen device 100 may store a position of a data point around the L-shaped contact point. A data point refers to a contact point that has two-dimensional coordinates described above. As the contact point is used as one piece of identification information, it may be referred to as a data point. The data point may be stored in the operation tool register DB inside the touch screen device 100 or in a DB of an external device.

In operation S940, the touch screen device 100 may align the stored position of the data point with respect to a right-upright position of the L-shaped contact point. This operation is performed in order to accurately identify the position of the data point by re-ordering the position of the data point based on a different standard from the L-shaped contact point, and may also be omitted.

In operation S950, an angle of the L-shaped contact point may be calculated and an angle of the guide operation tool 300 on the touch screen unit 110 may be calculated based on the calculated angle of the L-shaped contact point. As the L-shaped contacting portion of the guide operation tool 300 may be set to be parallel to an outer shape of the guide operation tool 300, the touch screen device 100 may recognize a rotational state of the L-shaped contacting portion as a rotational state of the guide operation tool 300. The rotational state of the guide operation tool 300 is not information that is always needed in identifying the guide operation tool 300, and thus the above operation may also be omitted. Accordingly, the touch screen device 100 may store a grid pattern formed of positions of the data points in a DB and use the same as identification information of the guide operation tool 300. In the DB, identification information regarding the guide operation tool 300 may be stored in addition to the grid pattern.

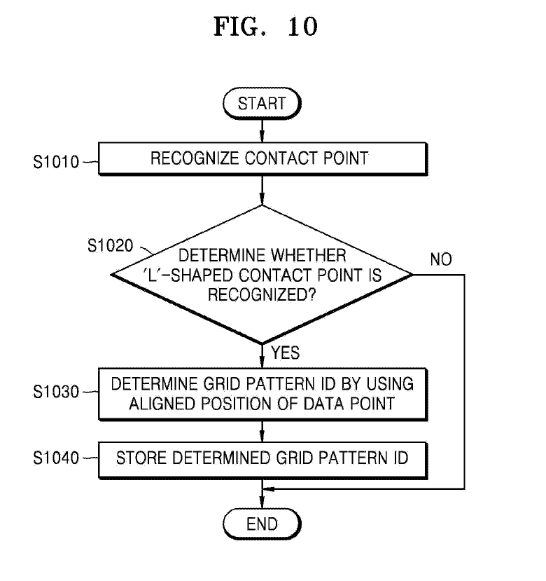

FIG. 10 is a flowchart illustrating a method of identifying an operation tool according to an embodiment. Like FIG. 9, a contacting portion will be assumed to be an L-shaped contacting portion.

In operation S1010, the touch screen device 100 may recognize a contact point of the guide operation tool 300. This operation has been described above in detail, and thus here description thereof will be omitted.

In operation 1020, the touch screen device 100 may determine whether an L-shaped contact point is recognized based on sensing information of the touch screen unit 110. The L-shaped contact point has a charge variation amount that is different from those of other contact points, and thus, whether an L-shaped contact point is recognized may be determined based on the different charge variation amount of the L-shaped contact point.

In operation 1030, a grid pattern ID may be determined by using a position of a data point aligned around the L-shape. Since the touch screen device 100 is already aware that there are data points (contact points) around the L-shaped contact point, the positions of the data points may be calculated as coordinate values and a grid pattern ID may be determined based on the combination of the coordinate values. Since it is assumed that there are no guide operation tools which have the same grid pattern, the grid pattern may be determined as one piece of identification information.

In operation S1040, the determined grid pattern ID may be stored in the touch screen device 100. By searching a grid pattern from DB, information of a guide operation tool that matches the stored grid pattern ID may be obtained. The information of the guide operation tool may include information about an operation area of the guide operation tool.

The method of registering and identifying the guide operation tool which is a first operation tool has bee described above. Information about an operation area of the first operation tool may be learned, and an operation of an auxiliary operation tool which is a second operation tool may be sensed in the operation area by the touch screen unit 110. Thus, hereinafter, an operation of the touch screen device 100 of sensing both the first operation tool and the second operation tool and an operation of the touch screen device 100 based on information obtained by the sensing will be described.

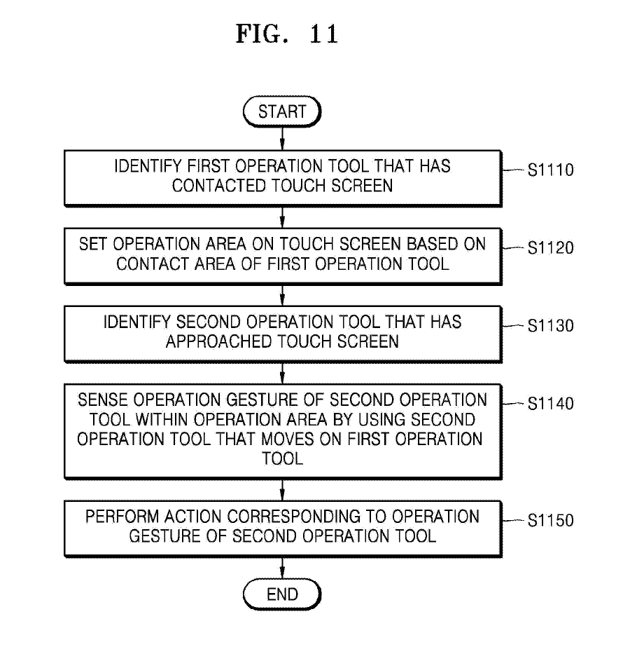

FIG. 11 is a flowchart illustrating a method of operating the touch screen device 100 according to various embodiments.

In operation S1110, the first operation tool sensing unit 120 may identify the guide operation tool 300 based on the contact by the guide operation tool 300 sensed on the touch screen unit 110.

In operation S1120, the operation action management unit 140 may set an operation area on the touch screen unit 110 based on an area contacted by the guide operation tool 300.

In operation S1130, the second operation tool sensing unit 130 may identify an auxiliary operation tool 200 based on an access by the auxiliary operation tool 200 sensed on the touch screen unit 110.

In operation S1140, the second operation tool sensing unit 130 may sense an operation gesture generated by the auxiliary operation tool 200 that moves on the guide operation tool 300 contacting the touch screen unit 110, in the operation area.

In operation 1150, the operation action management unit 140 may determine an event action corresponding to an operation gesture of the auxiliary operation tool 200 sensed in operation 1140 from among actions that are previously registered in the interaction DB. A predetermined event action may be performed in the touch screen device 100 according to a control signal of the action determined by the operation action management unit 140.

The touch screen device 100 according to various embodiments may sense an input by various operation tools but may identify only a previously registered operation tool from the various operation tools. The operation action management unit 140 may include an operation tool register DB in which identification information about operation tools having inputs that may be sensed is registered. When a contact or access of an operation tool is sensed by the first operation tool sensing unit 120 or the second operation tool sensing unit 130, a newly sensed operation tool may be searched for from among the operation tools previously registered in the operation tool register DB to be identified.

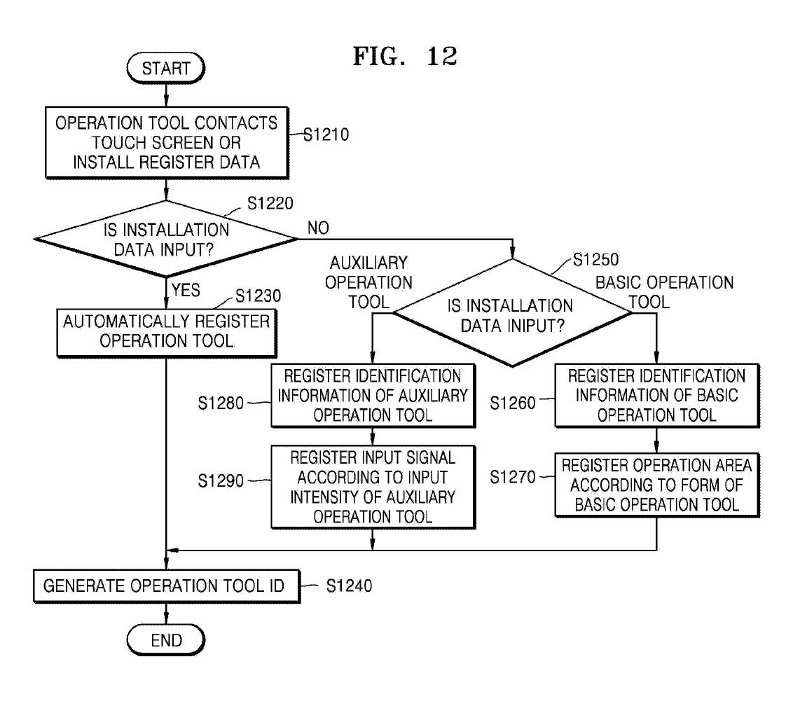

FIG. 12 is a flowchart illustrating a method of registering operation tools according to various embodiments. As an installation operation regarding operation tools that are previously registered and installed in the touch screen device 100 is not required, a method of registering operation tools that are not yet registered will be described below.

In operation S1210, the touch screen device 100 may receive a command for registering an operation tool. For example, when a contact or access by an operation tool on the touch screen unit 110 is sensed, an installation command of register data of an operation tool may be received.

In operation S1220, the touch screen device 100 may branch off a register process of an operation tool based on whether an installation command of register data of an operation tool is received or not. When an installation command of operation tool register data is received, the touch screen device 100 may perform an automatic register process by installing register data of an operation tool in operation S1230. Identification information and operation information or form information of an operation tool may be stored in a register DB based on the register data of the operation tool. In operation S1250, the operation action management unit 140 may generate an identification ID of the registered operation tool and store the same in the operation tool register DB.

In operation S1220, when an installation command of the operation tool register data is not received but contact or access by the operation tool is sensed, whether the sensed operation tool is the guide operation tool 300 or the auxiliary operation tool 200 may be determined in operation S1250.

When the guide operation tool 300 is sensed in operation S1250, the operation action management unit 140 may register identification information of the guide operation tool 300 in an operation tool register DB in operation S1260. For example, identification information including at least one of the number of contact points, the form of contact points, distance between contact points, and a surface area of a contact of the guide operation tool 300 may be stored in the operation tool register DB.

In operation S1270, the operation action management unit 140 may store information about the operation area 800 determined based on the form information of the guide operation tool 300, in the operation tool register DB. In operation S1240, an identification ID of the guide operation tool 300 may be generated and stored in the operation tool register DB.

When the auxiliary operation tool 200 is sensed in operation S1250, the operation action management unit 140 may register identification information of the auxiliary operation tool 200 with the operation tool register DB in operation S1280. For example, identification information including at least one of a sensitivity of pressing the auxiliary button 220 of the auxiliary operation tool 200 and a release sensitivity of the auxiliary button 220 may be stored in the operation tool register DB.

In operation S1290, the operation action management unit 140 may store operation information including at least one of a contacting sensitivity or release sensitivity of the contacting portion 210 of the auxiliary operation tool 200 and a distance between the contacting portion 210 and the touch screen unit 110, in the operation tool register DB. In operation S1240, an identification ID of the auxiliary operation tool 200 may be generated and stored in the operation tool register DB.

From among operation tools previously stored in the operation tool register DB, the touch screen device 100 may perform various event actions based on an operation gesture generated in a predetermined operation area by the auxiliary operation tool 200.

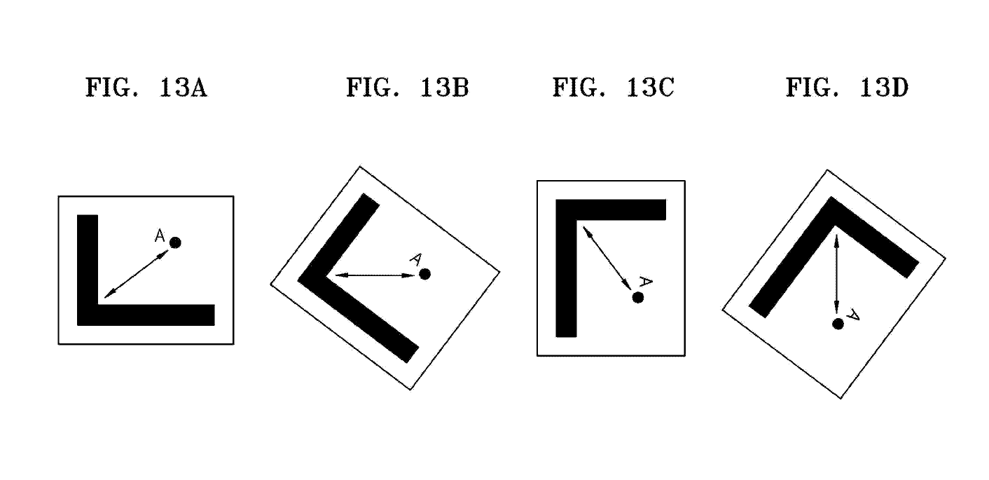

FIGS. 13A, 13B, 13C and 13D illustrate a rotational state of an operation tool according to various embodiments.

As illustrated in FIGS. 13A, 13B, 13C and 13D, the touch screen device 100 may determine a rotational state of a guide operation tool on the touch screen unit 110. The L-shaped contacting portion may be individed into two directions that are orthogonal to each other, and the two directions may be determined as a x-axis and a y-axis, respectively. Also, when a contact point A (a data point) is located on grid coordinates which is around a L-shaped contacting portion 325, an operation area of an auxiliary operation tool may be determined based on a rotational state of the L-shaped contacting portion 325. Combination of the rotational state of the L-shaped contacting portion 325 and a maximum distance between the contact points A and the L-shaped contacting portion 325 may be used as identification information of the guide operation tool 300.

FIG. 13A illustrates a state in which the guide operation tool 300 is not rotating. In this case, a rotational angle may be expressed as 0 degree. The touch screen device 100 may determine that a rotational angle of the guide operation tool 300 is 0 degree based on a parallel arrangement between the guide operation tool 300 and the contacting portion 325.

FIG. 13B illustrates the guide operation tool 300 that is rotated by about 30 degrees in a clockwise direction. The touch screen device 100 may recognize a position of an L-shaped contacting portion, and may sense a rotational state of the L-shaped contacting portion 325 via sensing portions 112 and 114 on the touch screen unit 110. Also, in FIGS. 13C and 13D, the touch screen device 100 may sense that the L-shaped contacting portion 325 is rotated clockwise (or counter-clockwise).

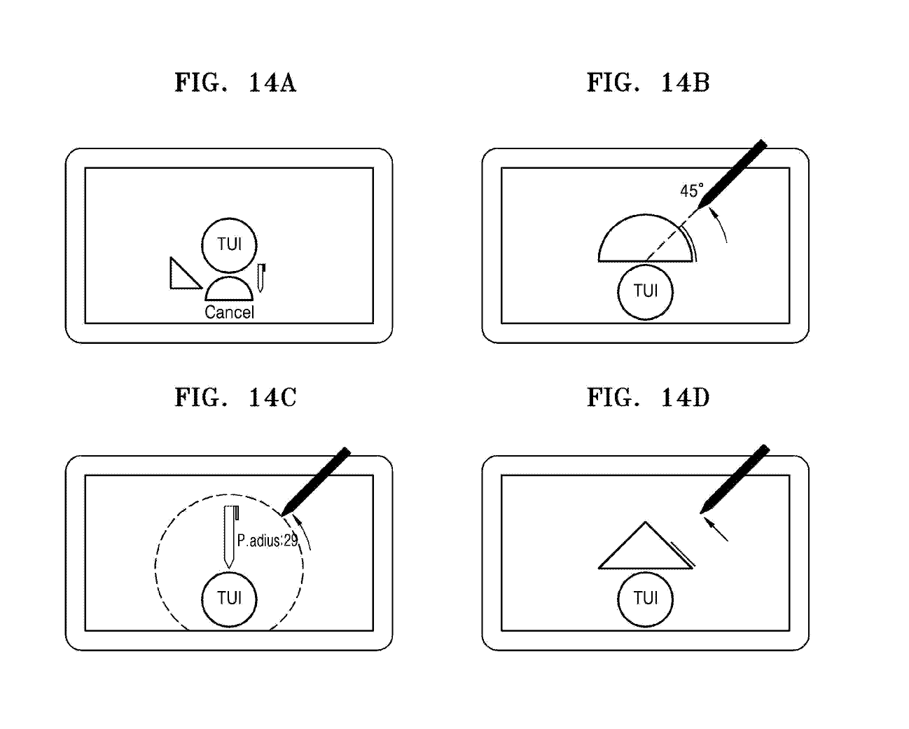

FIGS. 14A, 14B, 14C and 14D illustrate a method of operating the touch screen device 100 by using a rotational state of an operation tool according to various embodiments.

As described above with reference to FIGS. 13A, 13B, 13C and 13D, as the touch screen device 100 may sense a rotational state of the guide operation tool 300, a user may be provided with an application that uses a rotational state of the guide operation tool 300 and the auxiliary operation tool 200.

When the guide operation tool 300 is identified, the touch screen device 100 may determine a type of an operation area of the guide operation tool 300 based on identification information of the guide operation tool 300. Thus, an application that a user may use may be displayed on the touch screen unit 110 according to the operation area.

As illustrated in FIG. 14A, the guide operation tool 300 is a tangible user interface (UI) and thus may be provided as a tangible user interface (TUI). A TUI object corresponding to the guide operation tool 300 may be displayed on the touch screen unit 110, and objects whereby the guide operation tool 300 may be used as a single tool by the user may also be displayed on the touch screen unit 110. Referring to FIG. 14A, it is displayed that the guide operation tool 300 may be used as a triangle, a protractor or a compass. In addition, a cancel object prepared for a case where the guide operation tool 300 is used as none of the displayed tools may also be displayed.

As illustrated in FIG. 14B, an application whereby the user may use the guide operation tool 300 as a protractor may be executed. If a shape of the guide operation tool 300 obtained by using the identification information of the guide operation tool 300 is a semicircle, the touch screen device 100 may receive an operation input of the user by using the guide operation tool 300 and the auxiliary operation tool 200. When movement of the auxiliary operation tool 200 is sensed, the touch screen device 100 may display a rotational state of the guide operation tool 300 on the touch screen unit 110. For example, if a pressed state of the auxiliary button 220 of the auxiliary operation tool 200 is sensed, and movement of the auxiliary operation tool 200 according to a curved portion having a shape of a protractor is sensed, the touch screen device 100 may display a variation in an angle of the auxiliary operation tool 200 according to movement of the auxiliary operation tool 200 on the touch screen unit 110 based on a position of the auxiliary operation tool 200 at a time point when the auxiliary button 220 is pressed.

As illustrated in FIG. 14C, an application whereby the user may use the guide operation tool 300 as a compass may be executed. If a shape of the guide operation tool 300 obtained by using the identification information of the guide operation tool 300 includes a curved surface, the touch screen device 100 may receive an operation input of the user by using the guide operation tool 300 and the auxiliary operation tool 200. When movement of the auxiliary operation tool 200 is sensed, the touch screen device 100 may display a rotational state of the guide operation tool 300 on the touch screen unit 110. For example, if a pressed state of the auxiliary button 220 of the auxiliary operation tool 200 is sensed, and movement of the auxiliary operation tool 200 according to a curved portion of the guide operation tool 300 is sensed, the touch screen device 100 may display a variation in a path of the auxiliary operation tool 200 according to movement of the auxiliary operation tool 200, on the touch screen unit 110 based on a position of the auxiliary operation tool 200 at a time point when the auxiliary button 220 is pressed.

As illustrated in FIG. 14D, an application whereby the user may use the guide operation tool 300 as a triangle may be executed. If a shape of the guide operation tool 300 obtained by using the identification information of the guide operation tool 300 is a triangle, the touch screen device 100 may receive an operation input of the user by using the guide operation tool 300 and the auxiliary operation tool 200. When movement of the auxiliary operation tool 200 is sensed, the touch screen device 100 may display a rotational state of the guide operation tool 300 on the touch screen unit 110. For example, if a pressed state of the auxiliary button 220 of the auxiliary operation tool 200 is sensed, and movement of the auxiliary operation tool 200 according to a boundary surface of the guide operation tool 300 is sensed, the touch screen device 100 may display a variation in a path of the auxiliary operation tool 200 according to movement of the auxiliary operation tool 200, on the touch screen unit 110 based on a position of the auxiliary operation tool 200 at a time point when the auxiliary button 220 is pressed. A diagonal line may be displayed according to the variation in the path.

Hereinafter, a method of receiving an action that operates a content displayed on the touch screen unit 110 and performing an event corresponding to the content will be described.

FIG. 15 illustrates an operation of storing a content corresponding to an operation area according to various embodiments.

As illustrated in FIG. 15, a predetermined content may be being executed on the touch screen unit 110. For example, an image object may be displayed or a video may be being replayed. When an operation area of the guide operation tool 300 is determined while a content is being displayed on the touch screen unit 110, the touch screen device 100 may store a content corresponding to a corresponding operation area. Here, the storing operation refers to extraction of only the corresponding operation area from an existing content and generating the same as an additional content, and this storing operation may also be referred to as a crop operation. Upon receiving an operation input in the form of a closed curve regarding a predetermined area from the auxiliary operation tool 200 which is moving on the operation area, the touch screen device 100 may store a content corresponding to the closed curve. Since a precise operation input is not able to be received from the user, a content corresponding to a closed curve is not necessarily to be stored, and a content that has a largest ratio around a boundary of the closed curve may be selected and stored. As illustrated in FIG. 15, if two images representing mountains (hereinafter referred to as mountain images) and an image representing a sun between the mountains (hereinafter referred to as a sun image) are displayed on the touch screen unit 110, and the guide operation tool 300 is identified, an operation area of the guide operation tool 300 may be determined. When it is determined that the guide operation tool 300 having a rectangular shape is touched on the sun image displayed on the touch screen unit 110, the mountain images around the sun image may be stored as a single image with respect to the operation area as a boundary. Alternatively, since it is determined that the sun image has the largest ratio within the operation area, only the sun image may be selected and stored as an image.

A content corresponding to an operation area may be stored by using the guide operation tool 300 and the auxiliary operation tool 200 in combination. When an input of the auxiliary operation tool 200 is also received, a content corresponding to an area selected according to the input of the auxiliary operation tool 200 (for example, a closed curve input) may be stored.

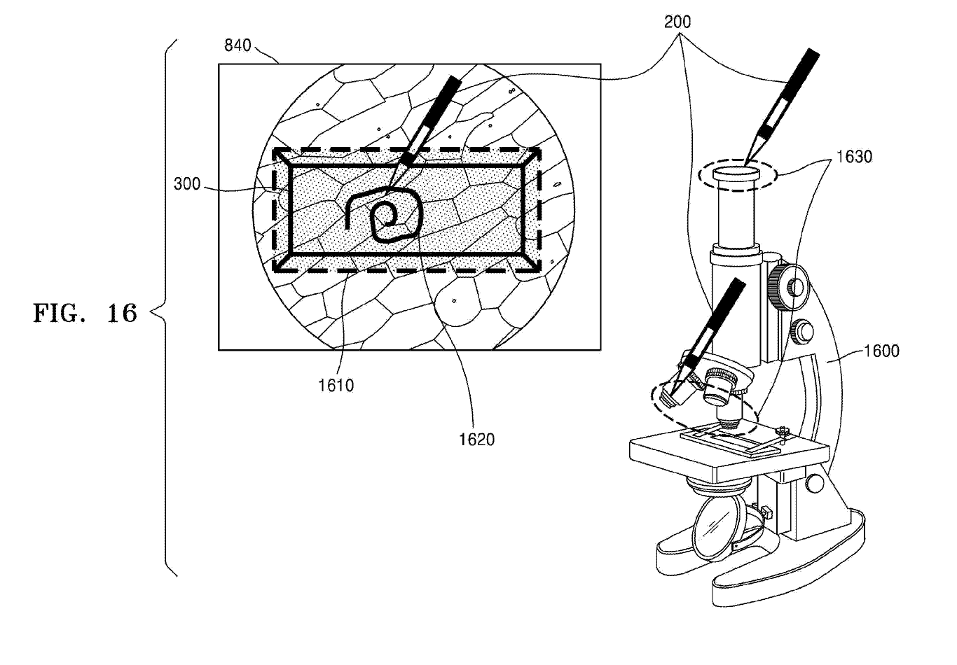

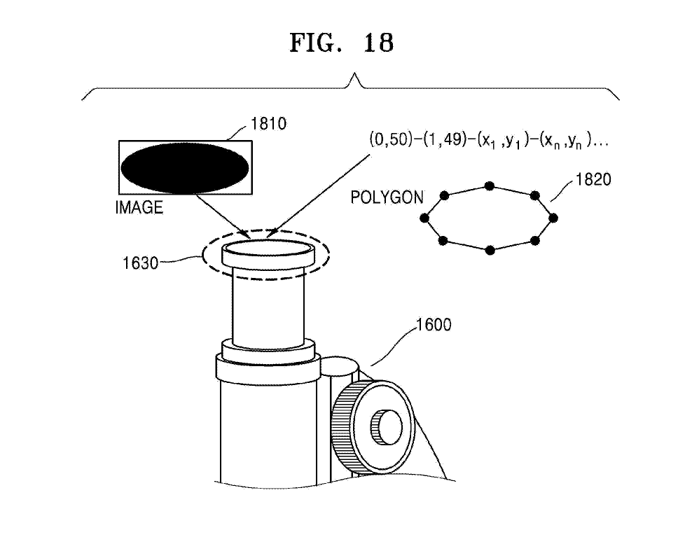

FIGS. 16, 17, and 18 illustrate an operation area according to various embodiments.

The touch screen device 100 may execute a virtual experiment application, thereby displaying an application screen 1600 illustrating a microscope on the touch screen unit 100. An operation area according to various embodiments may include a physical operation area 1610 that is determined based on the guide operation tool 300 and a virtual operation area 1630 determined on the application screen 1600.

In the physical operation area 1610 or the virtual operation area 1630, an operation gesture according to the auxiliary operation tool 200 may be sensed. An operation gesture of the auxiliary operation tool 200 may include a state where a single operation by the auxiliary operation tool 200 is input, or a state where a series of multiple operations is input.

Referring to FIG. 16, when the virtual operation area 1630 indicating an object lens of the microscope is selected by the auxiliary operation tool 200, a cell tissue expansion screen 1640 may be displayed on the touch screen unit 110. The physical operation area 1610 may be set as the guide operation tool 300 contacts the touch screen unit 110 on which the cell tissue expansion screen 1640 is displayed. An operation gesture 1620 may be input according to movement of the auxiliary operation tool 200 within the physical operation area 1610.

Referring to FIG. 16, the physical operation area 1610 may be determined based on the form of the guide operation tool 300 that contacts the touch screen unit 110. As the auxiliary operation tool 200 moves on the guide operation tool 300, the operation gesture 1620 by the auxiliary operation tool 200 may be input within the physical operation area 1610. When the guide operation tool 300 is formed of a transparent or a semi-transparent material, a user may see through the guide operation tool 300 to observe an image displayed on a screen within the physical operation area 1610 and the operation gesture 1620 performed by the auxiliary operation tool 200.

Although the second operation tool sensing unit 130 may sense an input by the auxiliary operation tool 200 in an outer portion of the physical operation area 1610, the operation action management unit 140 may disregard any input by the auxiliary operation tool 200 that is sensed as being outside of the physical operation area 1610.

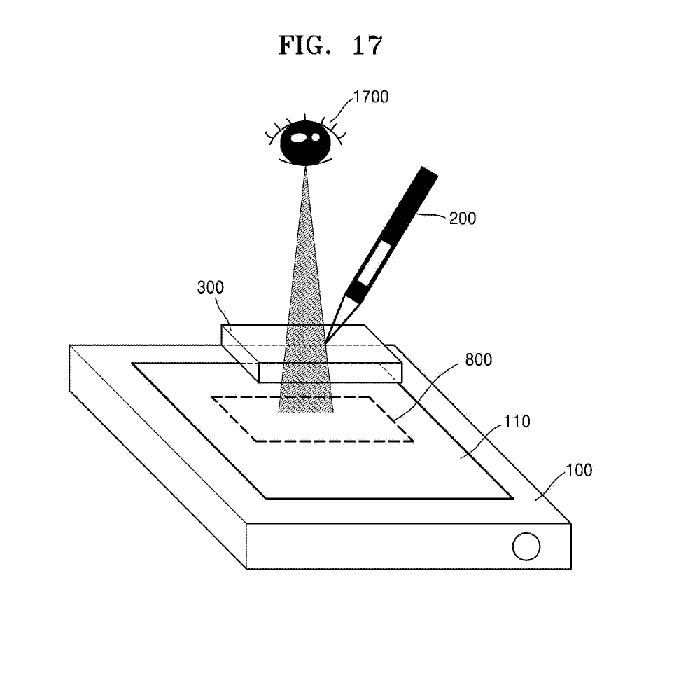

Referring to FIG. 17, an image 1010 of a partial area corresponding to the virtual operation area 1630 on the application screen 1600 may be determined as the virtual operation area 1630. Alternatively, polygonal coordinates information that is obtained by approximating the form of the virtual operation area 1630 on the application screen 1600 may be determined as the virtual operation area 1630.

Upon input of an operation gesture by operation tools, the operation action management unit 140 of the touch screen device 100 according to various embodiments may perform an event action corresponding to the operation gesture of operation tools, based on the operation register DB and the interaction DB. That is, from among event actions previously registered in the interaction DB, an event action corresponding to a series of operation gestures input by at least one operation tool of the guide operation tool 300 and the auxiliary operation tool 200 may be determined.

Also, an application for performing event actions of a predetermined job may be executed on the touch screen device 100 based on a user input via operation tools. An application may also define information about an event action corresponding to an operation gesture of operation tools to perform a predetermined job.

Accordingly, the touch screen device 100 may map corresponding relationships between operation gestures of operation tools to event actions, to the operation action management unit 140 and the application.

Accordingly, the operation action management unit 140 may map information about an event corresponding to the virtual operation area 1630 defined in the application and an operation gesture of at least one operation tool, to event actions registered in the interaction DB.

When an application executing unit (not shown) executes an application, the operation action management unit 140 may determine event actions corresponding to operation gestures performed in the virtual operation area 1630 when an operation gesture of the auxiliary operation tool 200 is sensed in the virtual operation area 1630.

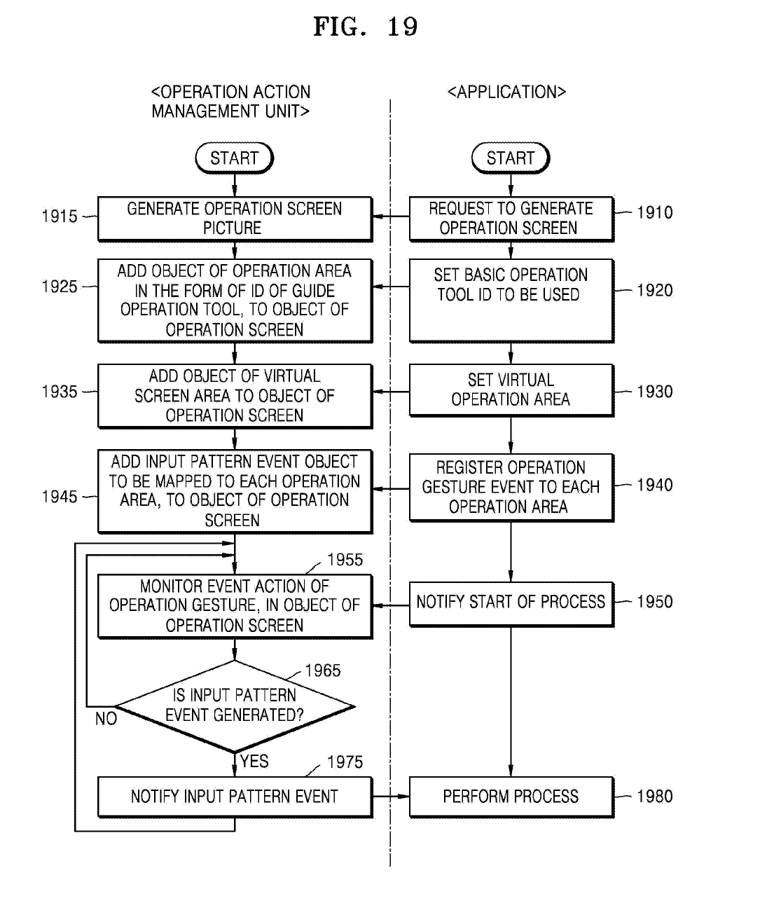

FIG. 19 is a flowchart illustrating a method of mapping an operation action management unit to an application according to various embodiments.

When an application is executed, an operation gesture input by using an operation tool is input through the application, and thus, the application executing unit transfers the operation gesture input by using the operation tool to the operation action management unit 140, and the operation action management unit 140 may generate a control signal according to the operation gesture.

In operation 1910, when the application executing unit (not shown) requests the operation action management unit 140 to generate the application screen 1600 on which inputs may be made, the operation action management unit 140 may generate an object of the application screen 1600 according to the request in operation 1915. When the object of the application screen 1600 is transferred to the touch screen unit 110, the application screen 800 may be displayed.

In operation 1920, when the application executing unit selects the guide operation tool 300 to be used and assigns an identification ID to the guide operation tool 300, the operation action management unit 140 may add an object of the physical operation area 1610 of the guide operation tool 300 corresponding to the identification ID to the object of the application screen 800 in operation 1925. When the object of the operation area 1610 is transferred to the touch screen unit 110, the operation area 1610 may be displayed on the application screen 1600.

When the application executing unit (not shown) sets the virtual operation area 1630 in operation 1930, an object of the virtual operation area 1630 may be added to the object of the application screen 1600 in operation 1935. When the object of the virtual operation area 1630 is transferred to the touch screen unit 110, the virtual operation area 1630 may be displayed on the application screen 1600.

In operation 1940, the application executing unit (not shown) may register event actions with the interaction DB according to operation gestures that are respectively input to the operation areas 1610 and 1630. Accordingly, in operation 1945, the operation action management unit 140 may add operation gesture event objects that correspond to the operation areas 1610 and 1630, to the object of the application screen 1600. The operation gesture event objects corresponding to the operation areas 1610 and 1630 may be additionally registered in the interaction DB.

When the application executing unit (not shown) notifies that a process start command has been requested, in operation 1950, then in operation 1955, the operation action management unit 140 may monitor whether an operation gesture event action is generated in the object of the application screen 1600. In operation 1965, when an operation gesture event action is not generated, the method returns to operation 1955 to further monitor whether an operation gesture event action is generated.

However, when an operation gesture event action is generated in operation 1965, the operation action management unit 140 notifies that an operation gesture event action has been generated, in operation 1975, and in operation 1980, the application executing unit (not shown) may perform a process corresponding to the operation gesture event action.

For example, when the application executing unit (not shown) has executed a virtual experiment application, an experiment screen object is generated, and an observation area on an experiment screen is set as an operation area object on the experiment screen, and operation gesture objects corresponding to experiment operations may be set. When an operation gesture corresponding to the set operation gesture objects is generated, a virtual experiment process may be performed.

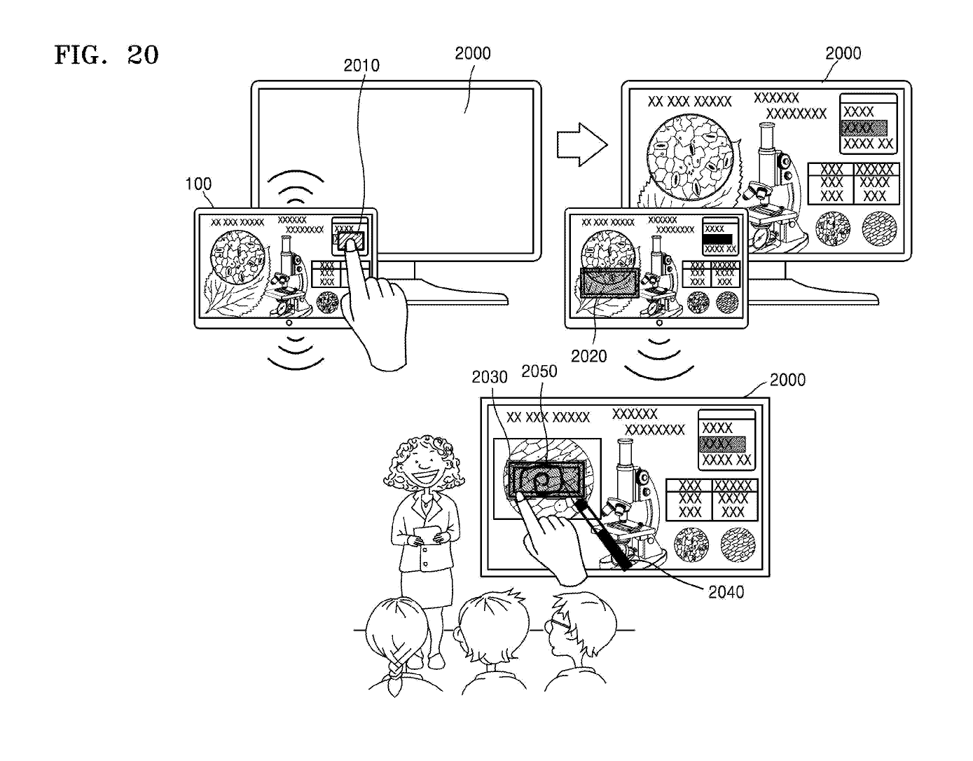

FIG. 20 illustrates a process in which actions are shared between the touch screen device 100 and an external device 2000 according to various embodiments.

The touch screen device 100 according to various embodiments may output a currently executed application screen to the external device 2000.

For example, when an external output icon 1210 on the application screen 800 is selected by a user input, image data regarding the current application screen 1600 may be transmitted to the external device 2000 as sharing information. The external device 2000 and the touch screen device 100 may share a screen with each other.

When screen sharing between the touch screen device 100 and the external device 2000 starts, the touch screen device 100 may display an operation area 2020 of a virtual guide operation tool on a screen of an application. The touch screen device 100 may transmit information about a position and a form of a virtual operation area of a virtual guide operation tool, as sharing information, to the external device 2000.

The touch screen device 100 may move the operation area 2020 of a virtual guide operation tool, based on a user operation. The touch screen device 100 may transmit information about a position of a virtual operation area of the virtual guide operation tool to the external device 2000 each time the position of the virtual operation area is updated.

The external device 2000 may display a current display screen and an operation area 2030 of the virtual guide operation tool based on the sharing information that is received from the touch screen device 100. Also, a user command may be input by using an input unit 2050 on the display screen of the external device 2000. Also, the external device 2000 may input an operation gesture by using an auxiliary operation tool 2040 within the operation area 2030 of the virtual guide operation tool.

For example, when an application is executed on the external device 2000, the external device 2000 may perform an event action corresponding to an operation gesture input by using the auxiliary operation tool 2040.

Alternatively, when only sharing information is transmitted to the external device 2000, and no application is being executed, information about an operation gesture of the auxiliary operation tool 2040 in the external device 2000 may be transmitted to the touch screen device 100 so that the touch screen device 100 may monitor an operation gesture of the auxiliary operation tool 2040. When an operation gesture registered in the interaction DB is performed, the touch screen device 100 may execute an event action corresponding to the operation gesture, and transmit a screen of a result of executing the event action, to the external device 2000 again, as sharing information. Accordingly, an execution screen of an application of the touch screen device 100 may be shared with the external device 2000 in real time.

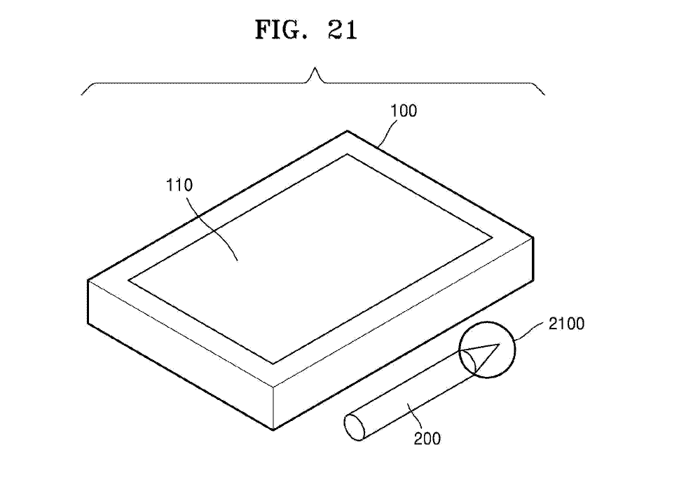

Hereinafter, operations of executing a virtual experiment application by using a guide operation tool and an auxiliary operation tool in the touch screen device 100 according to various embodiments will be described in detail with reference to FIGS. 21 through 29.

FIG. 21 illustrates a structure of a touch screen device 100 and an auxiliary operation tool 200 according to various embodiments.

The touch screen device 100 may include an auxiliary operation tool storage portion which the auxiliary operation tool 200 may be attached to or detached from the auxiliary operation tool storage portion.

An operation tool sensing unit 2100 may be disposed on the auxiliary operation tool detaching portion so that whether the auxiliary operation tool 200 is attached to or detached from the touch screen device 100 may be sensed.

The operation action management unit of the touch screen device 100 may register, as one of operation gestures of the auxiliary operation tool 200, information regarding the detaching or attaching of the auxiliary operation tool 200, with the operation tool register DB. Also, the operation action management unit may register event actions corresponding to attachment or detachment of the auxiliary operation tool 200, to the interaction DB.

As described above with reference to FIG. 19, when the touch screen device 100 executes an application in response to an event action and based on a relationship between an operation gesture of an operation tool defined in the application and the event action, the operation action management unit 200 may determine an operation gesture object of a currently input operation tool and an event action object corresponding to the operation gesture object. As the touch screen device 100 performs various event actions according to the object determined by the operation action management unit, a target process of the application may be performed.

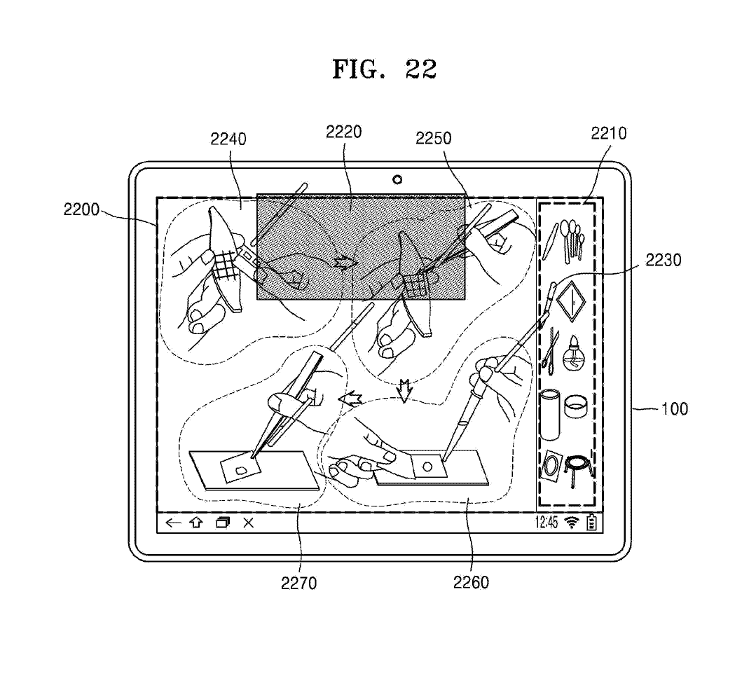

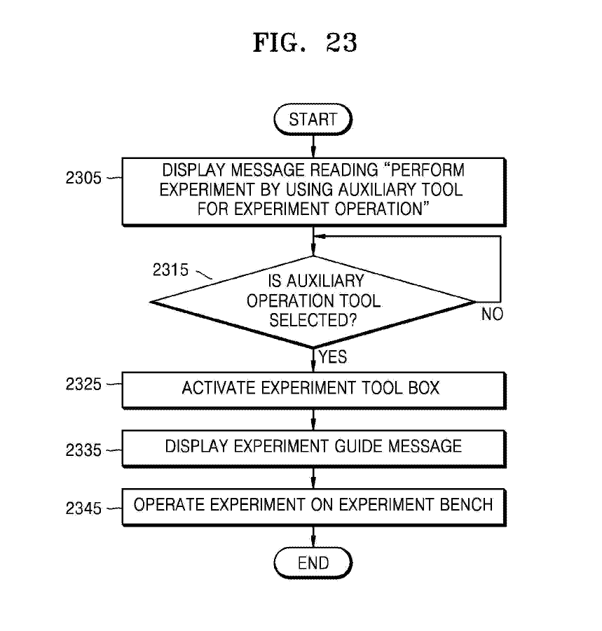

FIGS. 22 and 23 illustrate a virtual experiment screen of an experiment application executed by using the touch screen device 100 and a flowchart of a virtual experiment method, according to an embodiment.

When the touch screen device 100 executes an experiment application, according to an operation gesture made by a combination of at least one of the auxiliary operation tool 200 and the guide operation tool 300, audio-visual material for providing a virtual experience for a user to virtually perform an experiment may be produced.

For example, as an execution screen of an experiment application, an experimental bench screen 2200 may be reproduced. The operation action management unit 2200 may include a plurality of experiment operation windows 2240, 2250, 2260, and 2270. An experiment tool box 2210 and a message output window 2220 may be placed in a predetermined area of the experimental bench screen 2200.

In an area of the experiment tool box 2210, image objects of various experiment tools used in a virtual experiment may be included together in a group. For example, image objects of the experiment tool box 2210 and an experiment tool may be displayed such that images of a razor, tweezers, a pipette, a slide glass, a cover glass, a beaker, an alcohol lamp, a trivet, scissors or the like are included in the experiment tool box 2210.

When an operation gesture for selecting an image of an experiment tool image of the experiment tool box 2210 is input by using an operation tool such as the auxiliary operation tool 200, and an operation gesture for correlating the experiment tool image with a predetermined experiment operation window is input again, an event action for performing a virtual experiment while using a selected experiment tool within the virtual experiment may be performed.

Hereinafter, a virtual experiment process in which the touch screen device 100 according to various embodiments executes an experiment application to prepare a slide in a microscope experiment will be described in an order by referring to the flowchart of FIG. 23.

In operation 2305, as an event action for preparation of an experiment, a guide message which reads “perform an experiment by using an auxiliary tool for an experiment operation” may be displayed in the message output area 2220.

In operation 2315, the operation action management unit 140 may use an auxiliary operation tool detaching sensing unit 1300 to monitor whether a gesture whereby the auxiliary operation tool 200 is separated from the touch screen device 100 is sensed or not. If a separation gesture is not sensed, the operation action management unit 140 may continue the monitoring.

In operation 2325, when a separation gesture of the auxiliary operation tool 200 is sensed, the touch screen device 100 may activate the experiment tool box 2210. Then, the touch screen device 100 monitors whether a touch action or various operation gestures in the experiment tool box 2210 are sensed.

Next, when an operation gesture is performed whereby one of tools 1430 is selected from among the experiment tools illustrated in the experiment tool box 1410, an event action of selecting an experiment tool for a virtual experiment process may be performed. A gesture (Press Down) whereby the contacting portion 210 of the auxiliary operation tool 200 is pressed against an area where the experiment tool 2230 on the touch screen unit 110 is illustrated may be interpreted as a gesture (Select) for selecting an experiment tool.

In operation 2335, the touch screen device 100 may display a message for an experiment guide, on the message output area 1420.

Various event actions may be determined according to a combination of an operation tool being used, an experiment tool that is selected, a selected experiment operation window, and operation gestures. Even when the same operation pattern is input, in which the touch screen unit 110 is contacted by using the contacting portion 210 of the auxiliary operation tool 200 and the auxiliary button 220 is pressed and then released, if experiment tools selected from the experiment tool box 1410 and the selected experiment operation windows are different, the touch screen device 100 may determine that different operation gestures are being input.

Accordingly, the touch screen device 100 may display a guide message for guiding input of an experiment tool, an experiment operation window, and an operation gesture for each stage of an experiment action, on the message output area 2220.

In operation 2345, an experiment operation process may be executed on the experiment bench screen 2200 based on an operation gesture sensed by using the touch screen device 100.

The touch screen device 100 may perform an event action that is set according to a combination of an experiment tool, an experiment operation window, and an operation gesture that are input according to each stage of an experiment action.

For example, as an operation gesture for event actions of a microscope experiment, a scratching gesture, a peeling gesture, a spilling over gesture, or a covering gesture may be input.

A scratching gesture may denote an operation gesture for calling an event action corresponding to an experiment action of cutting an observation object illustrated on a first experiment operation window 2240 by using a razor. When a razor image is selected from the experiment tool box 2210 by using the auxiliary operation tool 200, the touch screen device 100 may recognize an operation gesture of drawing a line on the first experiment operation window 2240 as an input of the scratching gesture, and may perform an event action corresponding to the input scratching gesture.

In detail, continuous operation gestures of a gesture (Press Down) of pressing the auxiliary operation tool 200 against a knife image area from among other image areas included in the experiment tool box 2210 displayed on the touch screen unit 110 by using the auxiliary operation tool 200 and a gesture (Move) of moving an area of the first experiment operation window 2240 by using the contacting portion 210 of the auxiliary operation tool 200 may be recognized as a scratching gesture.

A peeling gesture may denote an operation gesture for calling an event action corresponding to an experiment action of tearing off a predetermined tissue from an observation object illustrated on a second experiment operation window 2250 by using tweezers. When an image of tweezers is selected from the experiment tool box 2210 by using the auxiliary operation tool 200, the touch screen device 100 may recognize an operation gesture of touching the second experiment operation window 2250 by using the auxiliary operation tool 200 as an input of a peeling gesture and may perform an event action corresponding to the input peeling gesture.

In detail, continuous operation gestures of a gesture (Press Down) of pressing the auxiliary operation tool 200 against a tweezers image area from among other image areas included in the experiment tool box 2210 displayed on the touch screen unit 110 by using the auxiliary operation tool 200 and a gesture (Move) of moving an area of the second experiment operation window 2250 by using the contacting portion 210 of the auxiliary operation tool 200 may be recognized as a peeling gesture.

A spilling over gesture may denote an operation gesture for calling an event action corresponding to an experiment action of dropping a drop of water on an observation tissue placed on a slide glass illustrated in a third experiment operation window 2260 by using a pipette. When an image of a pipette is selected from the experiment tool box 2210 by using the auxiliary operation tool 200, the touch screen device 100 may recognize an operation gesture of touching the third experiment operation window 2260 by using the auxiliary operation tool 200 as an input of a spilling over gesture and may perform an event action corresponding to the spilling over gesture.

In detail, a gesture (Press Down) of pressing the auxiliary operation tool 200 against a pipette image area from among other image areas included in the experiment tool box 2210 displayed on the touch screen unit 110 by using the auxiliary operation tool 200 and an operation gesture of touching a desired point from among an area of the third experiment operation window 2260 by using the contacting portion 210 of the auxiliary operation tool 200 and pressing and then releasing the auxiliary button 220 may be recognized as a spilling over gesture.

A covering gesture may denote an operation gesture for calling an event action corresponding to an experiment action of covering an observation tissue placed on a slide glass illustrated in a fourth experiment operation window 2270 with a cover glass. The touch screen device 100 may recognize an operation gesture of touching the fourth experiment operation window 2270 by using the auxiliary operation tool 200 as an input of a covering gesture and may perform an event action corresponding to the input covering gesture.

In detail, a gesture (Press Down) of pressing the auxiliary operation tool 200 against a cover glass image area from among other image areas included in the experiment tool box 1410 displayed on the touch screen unit 110 by using the auxiliary operation tool 200 and an operation gesture of touching a desired point from among an area of the fourth experiment operation window 2270 by using the contacting portion 210 of the auxiliary operation tool 200 and pressing and then releasing the auxiliary button 220 may be recognized as a covering gesture.

When the scratching gesture, the peeling gesture, the spilling over gesture, and the covering gesture of FIG. 22 are sequentially input, the touch screen device 100 may sequentially perform event actions respectively corresponding to the gestures. When the event actions respectively corresponding to the scratching gesture, the peeling gesture, the spilling over gesture, and the covering gesture are completed, an event action that provides notification that a prepared slide for a microscope experiment is completed may be generated.

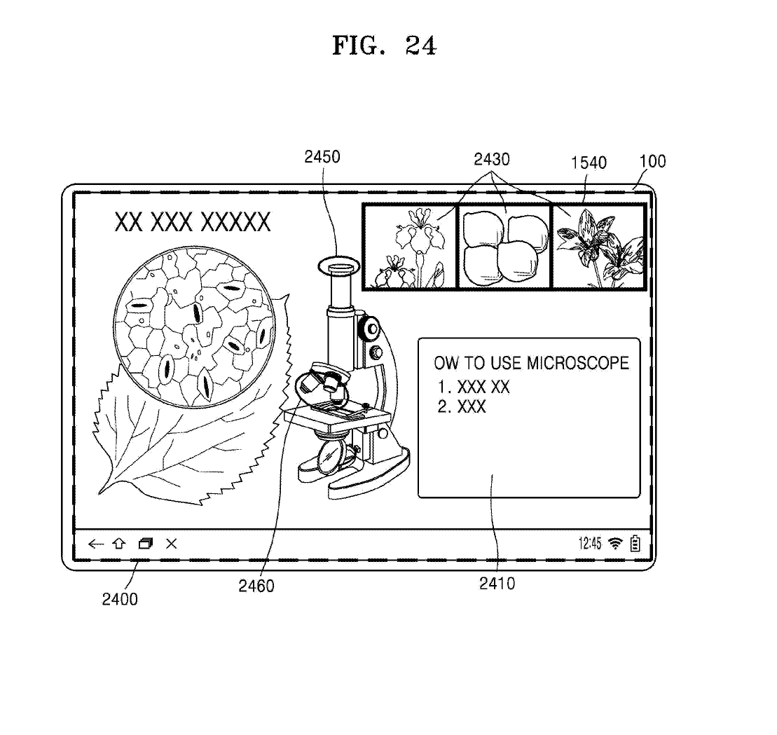

FIG. 24 illustrates a virtual microscope experiment screen 2400 of an experiment application, according to an embodiment.

The touch screen device 100 may display a virtual microscope experiment screen 2400 while executing an experiment application. The virtual microscope experiment screen 2400 may include first and second operation areas 2450 and 2460 via which a microscope may be manipulated by using an operation tool, and an experiment tool box area 2440. The first operation area 2450 may be set with respect to an ocular of a microscope, and the second operation area 2460 may be set with respect to an object lens of the microscope.

Also, the virtual microscope experiment screen 2400 may include a message output area 2410 for guiding a virtual experiment using a microscope.

When there are slides which have been previously completed and prepared by a manufacturing process of FIGS. 23 and 24, a prepared slide area 2430 on which images of previously completed prepared slides are displayed may be included in the experiment tool box area 2440.

For example, when an operation gesture (Press Down) of pressing the contacting portion 210 of the auxiliary operation tool 200 against the prepared slide area 2450 of the experiment tool box area 2440 is input, an event action of selecting a prepared slide to be observed by using a microscope may be generated.

For example, when an operation gesture (Press Down) of pressing the contacting portion 210 of the auxiliary operation tool 200 against the first operation area 2450 indicating an ocular of a microscope is input, an event action of observing a tissue cell of a prepared slide via the ocular may be generated. When the first operation area 2450 is selected, an expanded image of the cell tissue of the current prepared slide may be displayed. When the guide operation tool 300 is placed on an area of the expansion image, the physical operation area 1630 is activated, and an operation gesture of the auxiliary operation tool 200 with respect to the physical operation area 1630 may be input.

For example, when an operation gesture (Press Down & Move) of pressing the contacting portion 210 of the auxiliary operation tool 200 against the second operation area 2460 indicating an object lens of a microscope and moving the second operation area 2460 in a predetermined rotational direction is input, an event action of adjusting a lens magnification of the object lens may be generated.

Above, the embodiments regarding operation gestures for virtual experiment event actions for a microscope experiment are described in detail with reference to FIGS. 22, 23, and 24. However, the above-described embodiments are intended to help understand various embodiments of the touch screen device 100, and the operation gestures and the event actions that are implementable in the touch screen device 100 are not limited thereto.

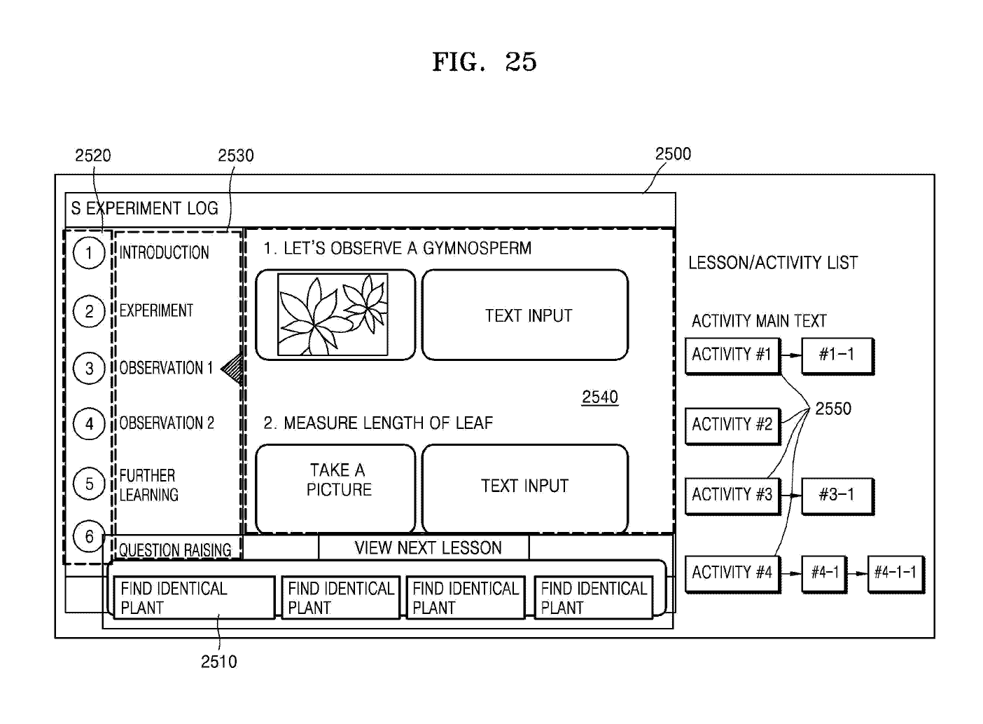

FIG. 25 illustrates a virtual experiment navigation screen of an experiment application according to an embodiment of the present invention.

The virtual experiment application according to the current embodiment may provide audio-visual contents and experiment activity modules for assisting a science class. Class contents may be classified by ‘lessons’ that are conducted according to a list of the contents. However, the learning progress of the science class according to the virtual experiment application according to the current embodiment may be classified by ‘activities’ that are conducted according to class stages of a user. For example, class stages of a user may be conducted in order of ‘motivation,’ ‘search,’ ‘concept introduction,’ ‘concept application,’ and ‘summary and evaluation.’ For example, class stages in a science experiment may be conducted in order of ‘introduction,’ ‘experiment,’ ‘observation,’ ‘further learning,’ and ‘question raising.’

That is, a lesson/activity list 2550 may be formed of a tree structure of text labels for various activities allocated to respective lessons (Activity #1, #2, #3, #4, #1-1, #3-1, #4-1, #4-1-1).

When the touch screen device 100 according to the current embodiment executes a virtual experiment application, a virtual experiment navigation screen 2500 for showing a current state of activities for each science class and result contents may be displayed.

The virtual experiment navigation screen 2500 may be formed of a lesson view area 2510, a stage division area 2520, an activity list area 2530, and a learning window area 2540.

The lesson view area 2510 may include icons via which each lesson may be selected for reference of a learning condition of a user.

Each stage of the stage division area 2520 and each learning activity of the activity list area 2530 are mapped in a one-to-one correspondence, and may be an object at which one stage icon may be selected in the stage division area 2520. Class activity videos of respective stages may be displayed on the learning window area 2540.

The touch screen device 100 according to the current embodiment may register an operation gesture for generating an event of an experiment application, to the operation action management unit 140, and may store, in the operation action management unit 140, monitoring information, lesson identification information, activity identification information, page identification information, or the like, which are generated while executing an application.

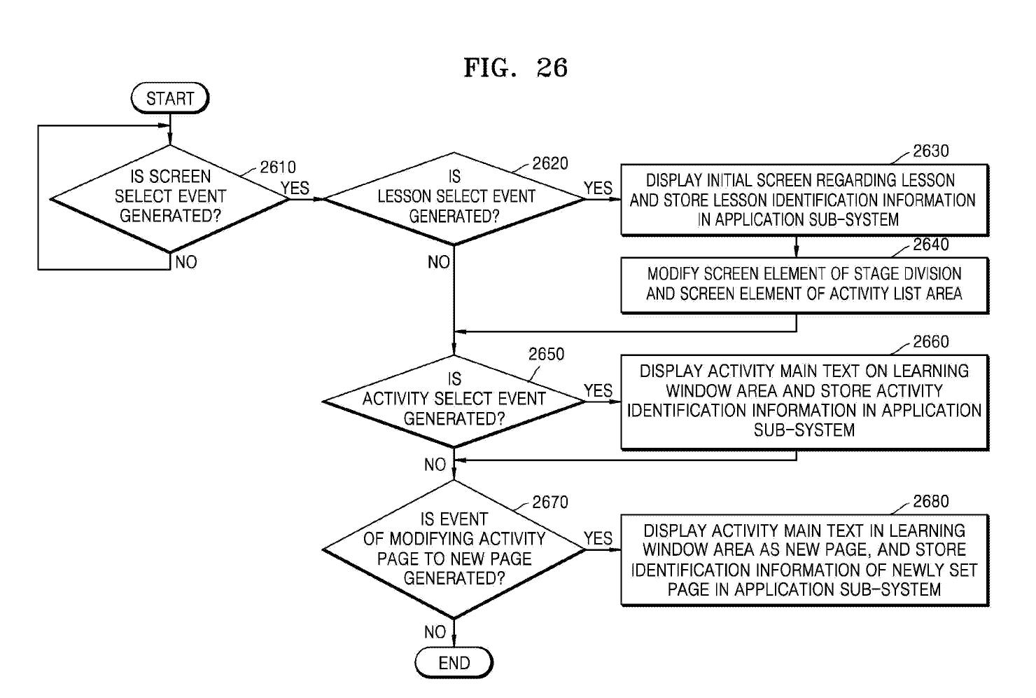

FIG. 26 is a flowchart illustrating a method of operating a virtual experiment navigation device of an experiment application according to an embodiment.

In operation 2610, the touch screen device 100 may monitor whether an event by which the virtual experiment navigation screen 2500 is selected is generated, for example, whether an operation gesture of contacting the virtual experiment navigation screen 2500 is input by using an operation tool. If there is no event, monitoring continues.

In operation 2610, when an operation gesture for selecting a screen is input on the virtual experiment navigation screen 2500, whether a lesson select event has been generated may be determined in operation 2620. For example, a touch operation regarding a lesson among the lesson view area 2510 of the virtual experiment navigation screen 2500 may be input. When a touch operation for selecting a lesson is input, the touch screen device 100 may perform an event action of displaying a first screen regarding the selected lesson and store the lesson identification information in the operation action management unit 140 in operation 2630.

In operation 2640, the touch screen device 100 may modify each screen element of the stage division area 2520 and each screen element of the activity list area 2530. A corresponding lesson stage may be displayed on the stage division area 2520 according to the selected lesson, and icons of selectable activities may be displayed according to the displayed class stage.

In operation 2650, the touch screen device 100 may monitor whether an activity selection event is generated. For example, a touch operation regarding an activity may be input from the activity list area 2530 of the virtual experiment navigation screen 2500. When a touch operation for selecting a lesson is input, the touch screen device 100 may perform an event action of displaying a selected activity main text on the learning window area 2540, and store activity identification information in the operation action management unit 140.

In operation 2670, the touch screen device 100 may monitor whether an activity page modification event is generated. For example, an operation of displaying a new activity page may be input from among the learning window area 2540 of the virtual experiment navigation screen 2500. When an operation of modifying an activity page is input, the touch screen device 100 may perform an event action of displaying a new activity page on the learning window area 2540 in operation 2680, and may store identification information of the newly set page, in the operation action management unit 140.

Accordingly, according to the virtual experiment navigation screen 2500 that is displayed by a virtual experiment application according to the current embodiment, the touch screen device 100 may selectively display just an activity page for each class stage corresponding to a current lesson, without having to search for the entire application screen for each lesson and displaying the same.

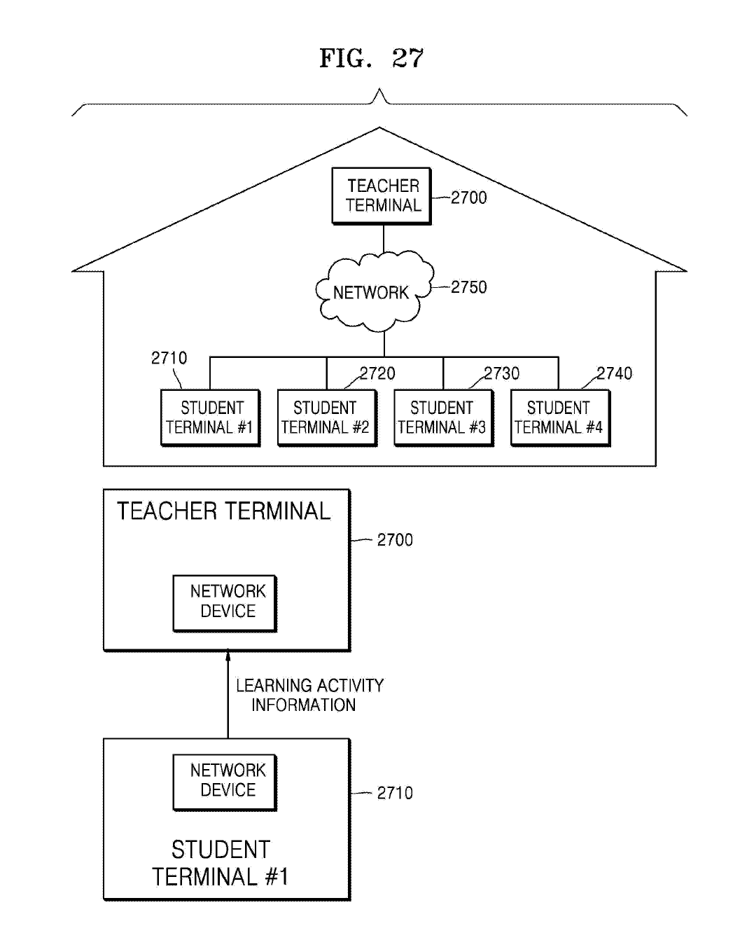

A plurality of terminals such as the touch screen device 100 according to various embodiments may simultaneously execute an experiment application. Hereinafter, various embodiments in which multiple terminals execute an experiment application in real time while a science class is being conducted will be described with reference to FIGS. 27 through 29.

FIG. 27 illustrates an operation of monitoring activities of an experiment application on a plurality of touch screen devices, according to an embodiment.

A student terminal #1 2710, a student terminal #2 2720, a student terminal #3 2730, and a student terminal #4 2740 may be connected to a teacher terminal 2700 via a network 3250. The teacher terminal 2700, the student terminal #1 2710, the student terminal #2 2720, the student terminal #3 2730, and the student terminal #4 2740 may each include at least components of the touch screen device 100. The teacher terminal 2700, the student terminal #1 2710, the student terminal #2 2720, the student terminal #3 2730, and the student terminal #4 2740 may execute the same experiment application.

The teacher terminal 2700 is a management terminal for the multiple student terminals 2710, 2720, 2730, and 2740 and may receive learning information displayed on the student terminals 2710, 2720, 2730, and 2740 in real time.

For example, each of the student terminals 2710, 2720, 2730, and 2740 may execute an experiment application, log into a user account, and initiate communication with respect to the teacher terminal 2700. While executing the experiment application, the student terminals 2710, 2720, 2730, and 2740 may sense a change in activity condition (i.e., sense learning activity information) and transmit sensed learning activity information to the teacher terminal 2700. As learning activity information, a student ID (user log-in ID), lesson identification information, activity identification information, and activity page identification information of a corresponding student may be transmitted to the teacher terminal 2700.

That is, the teacher terminal 2700 may monitor the status of a learning activity of a student in real time by using user identification information (student ID), lesson identification information, activity identification information, and activity page identification information received from the student terminal #1 2710.

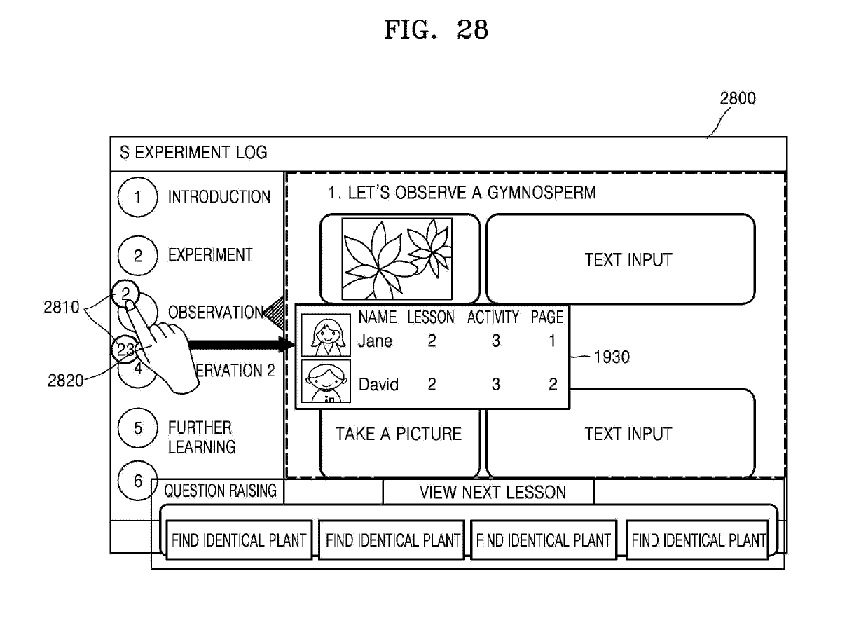

FIG. 28 illustrates a monitoring screen 2800 of a management terminal from among a plurality of mapped touch screen devices, according to an embodiment of the present invention.

A touch screen unit of the teacher terminal 2700 may display a monitoring screen 2800 which is a screen in which a monitoring function is added to the virtual experiment navigation screen 1600. A sub-icon 2810 indicating the number of students that are using a student terminal to view a page of an activity may be displayed on each corresponding activity icon of the monitoring screen 2800.

Upon sensing a touch gesture 2820 for selecting the sub-icon 2810 of each activity icon, the teacher terminal 2700 may further display a detailed monitoring screen 2830 regarding a student who is using a student terminal to view a corresponding activity page. The detailed monitoring screen 2830 may show activity information of students who are using student terminals to view a current activity page, that is, lesson identification information, activity identification information, or activity page identification information.

Accordingly, without having to move any screen additionally, the teacher terminal 2700 may perform an operation for a lesson while also displaying also a virtual experiment navigation screen via the monitoring screen 2800, and monitor an activity condition of student terminals in real time.

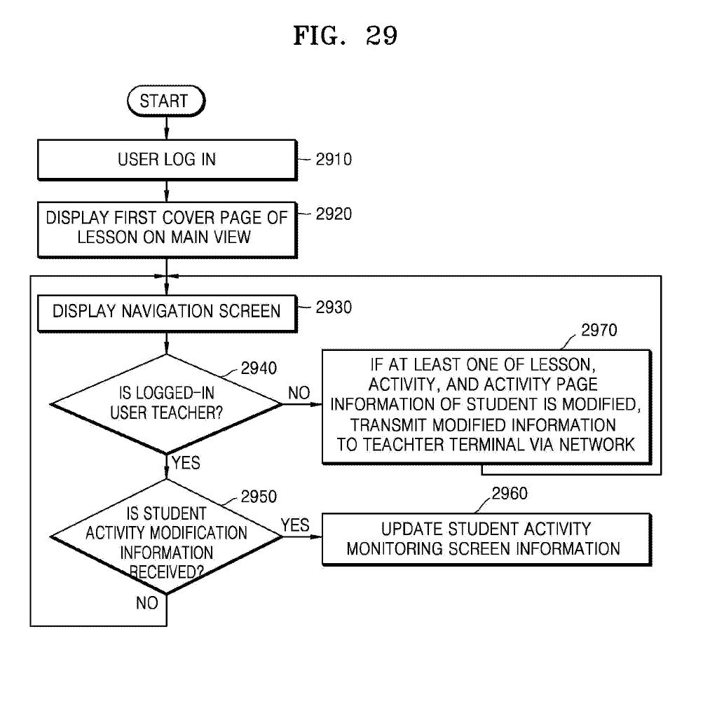

FIG. 29 illustrates the operation of a monitoring screen of a management terminal from among a plurality of mapped touch screen devices, according to an embodiment.

In operation 2910, the touch screen device 100 may display a first cover page of a lesson on the learning window area 2540 while displaying the navigation screen 2500 in operation 2920, and may also display the rest of the lesson view area 1610, the stage division area 2520, and the activity list area 2530 of the navigation screen 2500 in operation 2930.

In operation 2940, the touch screen device 100 may determine whether a user is a teacher or a student based on the user ID that is used to log in.

When a student ID is used to log in, the teacher terminal 2700 may be notified that the logged-in device is one of the student terminals 2710, 2720, 2730, and 2740. When it is assumed that the student ID of the student terminal #1 2710 is used to log in, and when at least one of the lesson identification information, activity identification information, and activity page identification information of a student is modified, the student terminal #1 2710 may transmit modified learning activity information to the teacher terminal 2700 via the network 3250.

When a teacher ID is used to log in, the touch screen device 100 may operate as the teacher terminal 2700. The teacher terminal 2700 may receive initial information of learning activity information including student ID information, lesson identification information, activity identification information, and activity page identification information from the student terminal #1 2710.

In operation 2950, the teacher terminal 2700 may monitor whether modified learning activity information is received. If modified information is not received, the method returns to operation 2930 and the experiment navigation screen 2500 or the monitoring screen 2800 may be displayed.

However, when modified learning activity information is received from the student terminal #1 2710, then in operation 2960, the teacher terminal 2700 updates the monitoring screen 2800, and may also update monitoring information of the operation action management unit 140 by using the updated learning activity information.

While the virtual experiment application or the science class application has been described as an example for helping understand the various embodiments of the touch screen device 100 with reference to FIGS. 16 through 29 above, the application executable by the touch screen device 100 is not limited to the virtual experiment application or the science class application. That is, the touch screen device 100 may perform various event actions by executing an application for generating an event action based on various operation gestures of at least one operation tool.

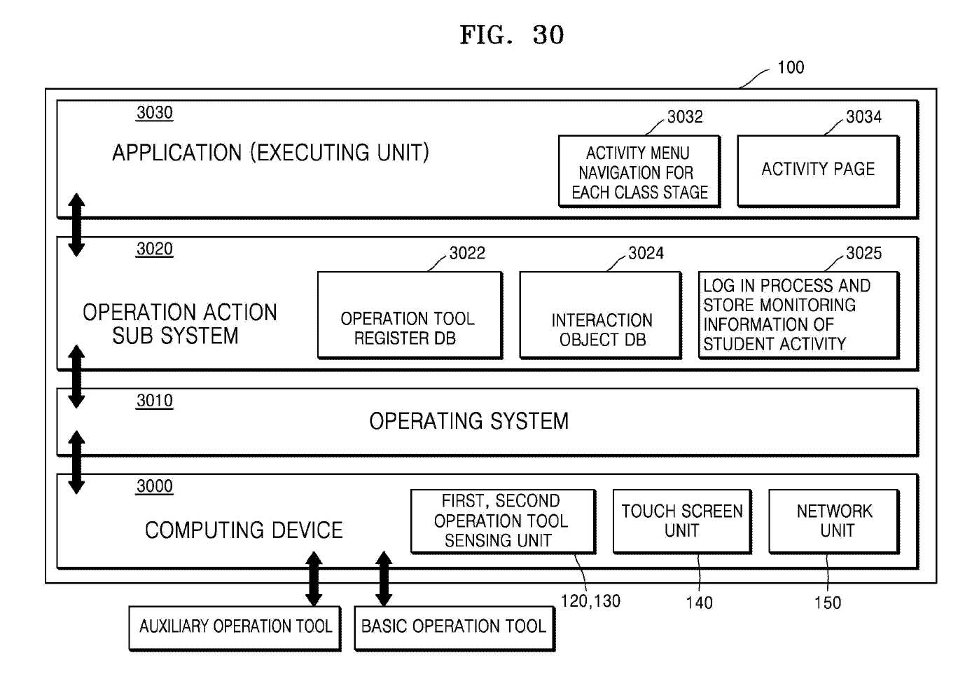

FIG. 30 illustrates a structure of a touch screen device 100 for use of an application, according to an embodiment.

Above have been described the various embodiments with reference to FIGS. 1 through 29, in which the touch screen device 100 executes a virtual experiment application based on inputs using an operation tool. Event actions generated or information that is modified as the touch screen device 100 executes an application may be all stored.

The touch screen device 100 may include a computing device 3000 that controls hardware components of the first and second operation tool sensing units 120 and 130, the touch screen unit 110, and the network unit 150. The computing device 3000 may execute a process by connecting a database of the operation action management unit 140 and objects of the application executing unit 3030 via hardware components in combination with an OS operating system 3010.

For example, the first and second operation tool sensing units 120 and 130 may sense a gesture of the guide operation tool 300 and the auxiliary operation tool 200, and may call the OS operating system 3010 and the operation action management unit 140 in order to interpret which event may be generated by the sensed gesture.

The operation action management unit 140 may manage an operation tool register DB 3022, an interaction object DB 3024, and a monitoring information DB 3025.

Information about an identification ID, a tool type, or a tool form of registered operation tools may be stored in the operation tool DB 3022. Also, as operation information, a control signal of the auxiliary button 220 of the auxiliary operation tool 200 and position recognition signals of the contacting portion 300 of the auxiliary operation tool 200 and the contacting portion 310 of the guide operation tool 300 may also be stored in the operation tool register DB 3022.

In the interaction object DB 3024, screen identification information which is an object to be operated, operation area information, operation gesture information, or the like may be stored.

In the monitoring information DB 3025, learning activity information such as a student ID, lesson identification information, activity identification information, activity page identification or the like may be stored.

The application executing unit 3030 may execute a class application for learning science, math, English, etc. Instead of sequentially displaying learning contents according to a list of lessons, the application executing unit 3030 may selectively display an activity page 3034 according to a lesson, on an activity menu navigation screen 3032 for each class stage.

The application executing unit 3030 may map set up information between an operation gesture and an event action defined in an application to the operation action management unit 140. Accordingly, the operation action management unit 140 may also determine an event action corresponding to gestures of the guide operation tool 300 and the auxiliary operation tool 200 regarding the application.

The operating system 3010 may transfer a control signal which corresponds to an event action determined by the operation action management unit 140 and the application executing unit 3030, to the computing device 3000, so that the touch screen unit 110 displays a result screen according to the event action.

As learning activity information of student terminals is transmitted to a teacher terminal via the network unit 150, the teacher terminal may monitor a learning condition of student terminals. Upon receiving modified activity condition information from the student terminals, the monitoring information DB 3025 of the teacher terminal may be updated.

An embodiment of the present invention may also be realized in a form of a recording medium including commands executable by a computer, such as a program module executed by a computer. A computer-readable recording medium may be an arbitrary available medium accessible by a computer, and may be any one of volatile, nonvolatile, separable, and non-separable media. Also, examples of the computer-readable recording medium may include a computer storage medium and a communication medium. Examples of the computer storage medium include volatile, nonvolatile, separable, and non-separable media realized by an arbitrary method or technology for storing information about a computer-readable command, a data structure, a program module, or other data. The communication medium may include a computer-readable command, a data structure, a program module, other data of a modulated data signal, such as carrier waves, or other transmission mechanisms, and may be an arbitrary information transmission medium.

While this invention has been particularly shown and described with reference to embodiments thereof, it will be understood by those of ordinary skill in the art that various changes in form and details may be made therein without departing from the spirit and scope of the invention as defined by the appended claims. The embodiments should be considered in a descriptive sense only and not for purposes of limitation. For example, each element described as a single type may be distributed, and similarly, elements described to be distributed may be combined.

The scope of the invention is defined not by the detailed description of the invention but by the appended claims, and all differences within the scope will be construed as being included in the present invention.

What is claimed is:

1. A method of operating a touch screen device, the method comprising:
identifying a first operation tool based on contact by the first operation tool, the contact being sensed on the touch screen device;
setting an operation area on the touch screen device based on an area designated by the contact by the first operation tool;
identifying a second operation tool based on access by the second operation tool, the access being sensed on the touch screen device;
sensing an operation gesture of the second operation tool within the operation area by using the second operation tool, wherein the second operation tool moves on the first operation tool and the first operation tool is in contact with the touch screen device; and
performing an action corresponding to the sensed operation gesture of the second operation tool from among actions that are previously registered in an interaction database (DB) of the touch screen device.

2. The method of claim 1, wherein the identifying a first operation tool comprises determining a position where the first operation tool contacts the touch screen device, by using an electrostatic sensor of the touch screen device, wherein the identifying a second operation tool comprises determining an input position of the second operation tool by using an electromagnetic induction sensor of the touch screen device.

3. The method of claim 1, wherein the identifying a first operation tool comprises identifying the first operation tool based on a sensed contacting state of the first operation tool, wherein the sensed contacting state of the first operation tool is from among identification information of operation tools registered with an operation tool register DB of the interaction DB,
wherein the setting an operation area on the touch screen device comprises determining an operation area of the identified first operation tool based on form information of operation tools that are previously registered with the operation tool register DB in the operation tool operation area,
wherein the identification information comprises at least one of a number of contact points of the first operation tool, a form of each of the contact points, a distance between the contact points, and a surface area of each of the contact points.

4. The method of claim 1, wherein the identifying a second operation tool comprises identifying the second operation tool based on a sensed access state of the second operation tool from among identification information of operation tools previously registered with an operation tool register DB of the interaction DB,
wherein the identification information comprises at least one of a sensitivity of pressing an auxiliary button of the second operation tool and a release sensitivity of the auxiliary button of the second operation tool.

5. The method of claim 1, wherein the identifying a first operation tool comprises:
storing, in an operation tool register DB, identification information of the first operation tool including at least one of a number of contact points of the first operation tool, a form of each of the contact points, a distance between the contact points, and a surface area of each of the contact points, which are stored in the interaction DB; and
storing information of an operation area determined based on a form of the first operation tool in the operation tool register DB.

6. The method of claim 1, wherein the identifying a second operation tool comprises:
storing identification information of the second operation tool including at least one of a sensitivity of pressing an auxiliary button of the second operation tool and a release sensitivity of the auxiliary button of the second operation tool, in an operation tool register DB; and
storing operation information of the second operation tool including at least one of a contact sensitivity or a release sensitivity of a contacting portion of the second operation tool and a distance between the contacting portion and the touch screen device, in the operation tool register DB.

7. The method of claim 1, wherein the interaction DB includes information about an action corresponding to an operation gesture of at least one of the first and second operation tools,
wherein the operation gesture of the at least one of the first and second operation tools is a single, previously set input or a set of a series of previously set inputs.

8. The method of claim 1, wherein the performing an operation corresponding to the sensed operation gesture of the second operation tool comprises determining an event action corresponding to a series of operation gestures which are input by using at least one of the first and second operation tools, from among the event actions that are previously registered in the interaction DB.

9. The method of claim 1, further comprising executing an application for performing an event determined based on an operation gesture of at least one of the first and second operation tools,
wherein the performing an operation corresponding to a sensed operation gesture of the second operation tool comprises:
mapping information about a virtual operation area defined in an application installed in the touch screen device to an event corresponding to an operation gesture of the at least one of the first and second operation tools, to the event actions previously registered with the interaction DB; and
performing, when a current operation gesture of the second operation tool is sensed within the virtual operation area as the application is executed, an action of an event corresponding to the current operation gesture.

10. The method of claim 1, wherein the performing an action corresponding to the sensed operation gesture of the second operation tool comprises displaying a result screen generated by the performing of the action, on the touch screen device.

11. The method of claim 1, wherein the performing an action corresponding to the sensed operation gesture of the second operation tool comprises:
receiving an output request which has been submitted to an external device;
transmitting image data about a current display screen of the touch screen device to the external device, based on the output request;
displaying a virtual operation area of the first operation tool on the touch screen device; and
transmitting information about a position and a form of the virtual operation area of the first operation tool, to the external device,
wherein when the current display screen and the virtual operation area are displayed on the external device, an operation gesture is sensed within the virtual operation area by using an operation tool of the external device.

12. The method of claim 1, further comprising:
receiving activity information including user identification information, lesson identification information, activity identification information, and activity page identification information, from each of a plurality of touch screen devices in which a same application is installed;
displaying an activity list including icons indicating activities and an activity page corresponding to the activity list, on the touch screen device and displaying, on each of the icons indicating the activities, a number indicating how many touch screen devices are displaying on each icon among the icons an activity from among the plurality of touch screen devices; and
displaying, when an input about the number is received, activity information of a user of a touch screen device that is displaying the activity page corresponding to the activity information of the user from among the touch screen devices.

13. The method of claim 1, further comprising transmitting activity information including user identification information, lesson identification information, activity identification information, and activity page identification information, to a management device from among a plurality of touch screen devices in which a same application is installed.

14. A touch screen device, comprising:
a touch screen unit that includes a display unit and a touch panel for outputting a display screen by converting image data to an electrical image signal;
a first operation tool sensing unit that senses contact by a first operation tool on the touch screen device and determines a position at which the first operation tool contacts the touch screen device;
a second operation tool sensing unit that senses access by a second operation tool on the touch screen and determines an input position of the second operation tool;
an operation action management unit that determines an action corresponding to an operation gesture of the second operation tool sensed in an operation area by the second operation tool, which moves on the first operation tool, from among actions that are previously registered in an interaction database (DB) of the touch screen device, and that outputs a control signal so that the action is performed; and
a network unit that transmits or receives data to or from an external device.

15. A method of operating a touch screen device, the method comprising:
identifying a first operation tool based on contact by the first operation tool, the contact being sensed on a touch screen; and
setting an operation area on the touch screen based on an area designated by the contact by the first operation tool,
wherein the identifying of a first operation tool comprises identifying based on a pattern formed of positions of a plurality of contact points arranged on the sensed first operation tool.

16. The method of claim 15, wherein the identifying a first operation tool comprises determining a position where the first operation tool contacts the touch screen device, by using an electrostatic sensor of the touch screen device.

17. The method of claim 15, wherein the identifying a first operation tool comprises identifying the first operation tool based on a sensed contacting state of the first operation tool, wherein the sensed contacting state of the first operation tool is from among identification information of operation tools registered with an operation tool register DB of the interaction DB,
wherein the setting an operation area on the touch screen device comprises determining an operation area of the identified first operation tool based on form information of operation tools that are previously registered with the operation tool register DB in the operation tool operation area,
wherein the identification information comprises at least one of a number of contact points of the first operation tool, a form of each of the contact points, a distance between the contact points, and a surface area of each of the contact points.

18. The method of claim 15, wherein the plurality of contact points arranged on the first operation tool are located around a contact point having a previously set form from among the contact points of the first operation tool, and are expressed as a combination of two-dimensional coordinate values.

19. The method of claim 15, wherein the identifying a first operation tool comprises:
storing, in an operation tool register DB, identification information of the first operation tool including at least one of a number of contact points of the first operation tool, a form of each of the contact points, a distance between the contact points, and a surface area of each of the contact points, which are stored in the interaction DB; and
storing information of an operation area determined based on a form of the first operation tool in the operation tool register DB.

20. The method of claim 15, wherein the setting an operation area on the touch screen comprises setting the operation area based on a rotational state of a contact point having the previously set form from among the contact points of the first operation tool.
